(19) United States
(12) Patent Application Publication
(10) Pub. No.: US 2026/0288804 A1
(43) Pub. Date: Sep. 24, 2026

(54) SYSTEM

(71) Applicant: SoftBank Group Corp., Tokyo (JP)

(72) Inventor: Shotaro KUMOZAKI, Tokyo (JP)

(73) Assignee: SoftBank Group Corp., Tokyo (JP)

(21) Appl. No.: 19/565,526

(22) Filed: Mar. 13, 2026

(30) Foreign Application Priority Data
Mar. 19, 2025 (JP) 2025-045240

(51) Int. Cl. G06F 16/3329; G06F 16/335; G06V 40/16; G10L 15/22

(52) U.S. Cl. CPC G06F 16/33295; G06F 16/337; G06V 40/174; G10L 15/22

(57) ABSTRACT

A system includes a processor that is configured to collect user interest data and user behavior data and analyze the collected data by using a natural language processing technique, generate a prompt sentence that instructs a generative AI model to generate custom information based on a result of the analysis, and recognize an emotion of a user and adjust generation and provision of the information based on the recognized emotion.

### CROSS-REFERENCE TO RELATED APPLICATION

This application is based on and claims priority under 35 USC 119 from Japanese Patent Application No. 2025-045240 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional information provision systems typically rely on static user profiles or simple behavioral logs, and are therefore insufficient to generate highly customized information that accurately reflects both the detailed interests and the emotional state of a user. In many existing systems, user behavior data such as viewing history, click history, and dwell time is collected but is not analyzed using natural language processing in a way that can flexibly control a generative AI model. As a result, generated information often remains generic and fails to adapt its content, tone, and presentation method to the user's current context. Furthermore, conventional systems rarely recognize and utilize user emotions as a dynamic parameter for information generation and delivery. This leads to problems such as providing information that is emotionally inappropriate, overwhelming, or unengaging for the user at a given time. There is thus a need for a system capable of: (i) collecting and analyzing user interest and behavior data by using natural language processing techniques, (ii) generating prompt sentences that precisely instruct a generative AI model to output custom information based on analysis results, and (iii) recognizing and reflecting user emotions so that both the generated content and its provision method are adaptively adjusted to the user's emotional state. The present invention has been made in view of these issues.

### SUMMARY

In order to solve the above-mentioned problems, a system according to one aspect of the present invention comprises a processor configured as follows. The processor is configured to collect user interest data and user behavior data, and to analyze the collected data by using a natural language processing technique. On the basis of a result of this analysis, the processor generates a prompt sentence that instructs a generative AI model to generate custom information adapted to the user's interests and behavioral tendencies. The processor is further configured to recognize an emotion of a user and to adjust generation and provision of the information based on the recognized emotion. For example, the processor may, when the emotion indicates stress or fatigue, instruct the generative AI model through an appropriate prompt sentence to generate information with a calmer tone or reduced complexity, and may modify a delivery schedule or presentation format accordingly. In some embodiments, the processor analyzes the user behavior data and generates a prompt sentence that instructs customization of subsequent information provision, thereby enabling iterative refinement of the generated content over time. In other embodiments, the processor analyzes the emotion of the user, selects a category of the information based on the analyzed emotion, and generates a prompt sentence that instructs generation of the information in the selected category. Through these configurations, the system can dynamically control a generative AI model in response to both analytical results of user behavior and the user's emotional state, thereby providing information that is more relevant, emotionally appropriate, and personalized for each user.

The term “processor” refers to a hardware device or a combination of hardware and firmware that executes instructions of a program to perform data collection, analysis, prompt generation, emotion recognition, and control of information generation and provision in the system.

The term “user interest data” refers to data indicating preferences, likes, or areas of concern of a user, including but not limited to topics, categories, keywords, or entities with which the user has interacted or expressed interest.

The term “user behavior data” refers to data representing actions performed by the user when interacting with information or content, including but not limited to viewing history, click history, scroll behavior, dwell time, and sharing actions.

The term “natural language processing technique” refers to a computational method or algorithm for processing, analyzing, or understanding natural language text or speech, including but not limited to tokenization, parsing, semantic analysis, sentiment analysis, topic modeling, and text classification.

The term “analysis result” refers to information derived from applying a natural language processing technique or other analytical methods to the collected user interest data and user behavior data, such as identified topics of interest, inferred preferences, behavioral patterns, or summarized user profiles.

The term “prompt sentence” refers to a text-based instruction or query generated by the processor and supplied to a generative AI model, the instruction specifying conditions, constraints, or objectives for generating custom information.

The term “generative AI model” refers to a machine learning model configured to generate text or other content in response to an input prompt sentence, including but not limited to large language models, transformer-based models, and neural network-based text generation models.

The term “custom information” refers to information generated by the generative AI model in response to a prompt sentence and tailored to a specific user, taking into account at least the user interest data, the user behavior data, or the emotion of the user.

The term “emotion of a user” refers to an affective state of the user, such as happiness, sadness, stress, calmness, excitement, or frustration, which is inferred or recognized based on at least one of user input, facial expression, voice, text content, physiological signals, or behavioral patterns.

The term “recognize an emotion” refers to determining or estimating the emotion of a user by applying analysis methods, which can include natural language processing, pattern recognition, machine learning, or multimodal analysis, to one or more types of user-related data.

The term “generation of the information” refers to a process in which the generative AI model produces custom information, such as text content, summaries, explanations, or recommendations, according to the constraints and conditions specified in a prompt sentence.

The term “provision of the information” refers to delivering or presenting generated information to the user through a user interface, including but not limited to displaying on a screen, outputting via audio, or transmitting to another device or application.

The term “customization of next information provision” refers to adjusting at least one aspect of subsequent information generation or delivery, such as topic, category, tone, volume, timing, or format, based on analysis of the user behavior data and previously recognized emotions.

The term “category of the information” refers to a classification label or type assigned to information, such as news, sports, entertainment, politics, technology, health, or environment, which is used by the processor to select or organize the content to be generated.

The term “selected category” refers to a category of the information that is chosen by the processor based on at least one of the user's emotion, user interest data, or user behavior data, and used as a condition in generating a prompt sentence for the generative AI model.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

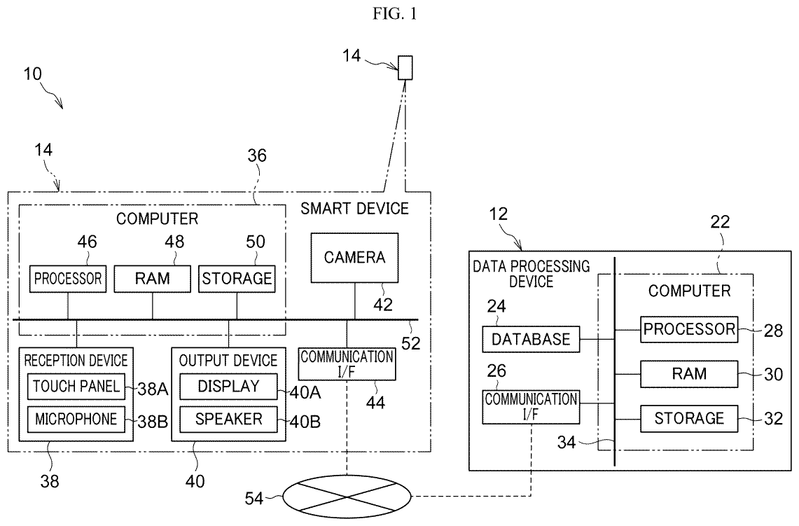

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

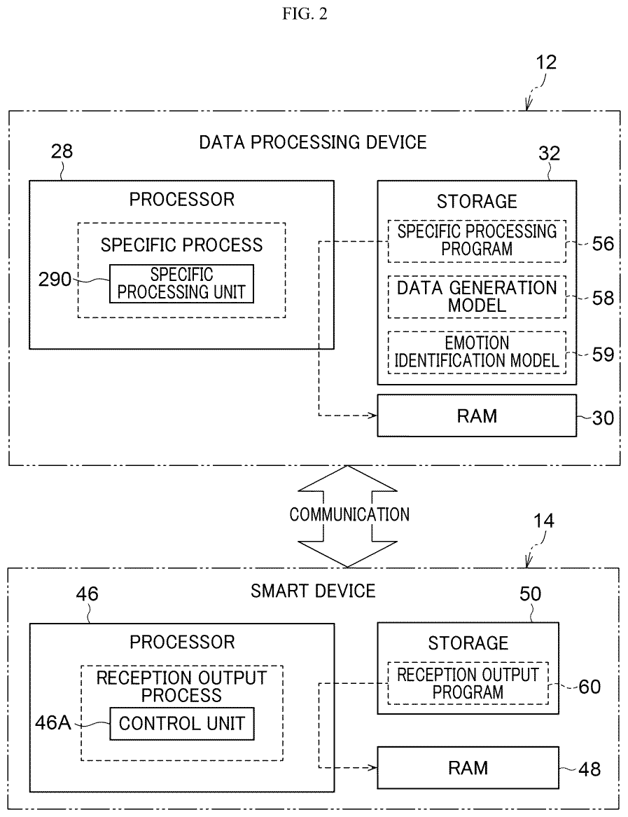

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional information provision systems that use machine learning or natural language processing typically treat user behavior logs as coarse-grained statistics and use static or weakly adaptive recommendation rules. In such systems, a server may collect page views or simple ratings and then select pre-existing content items based on aggregate scores. However, these systems generally fail to dynamically exploit fine-grained user interaction data and emotional state information to control, at the level of a prompt sentence, how a generative AI model produces content. As a result, several technical problems arise in computer-implemented information delivery.

First, existing systems often separate behavior analysis from content generation, resulting in a loose coupling between analytics components and language generation components. A conventional server may compute user preferences offline, while a generative model is invoked with generic, hand-crafted prompts. Because the server is not configured to systematically encode detailed, computed user attributes and interaction histories into the prompt sentences, the generative AI model operates without precise, context-rich guidance.

This leads to computational inefficiency and suboptimal use of processing and memory resources, as the model repeatedly generates broad, unfocused outputs that do not match user needs, increasing network traffic, processing time, and storage overhead for discarded or ignored content.

Second, conventional systems lack a mechanism to iteratively and programmatically refine the prompt sentences based on real-time user behavior with respect to previously generated outputs. Even when some adaptation occurs, it is usually confined to selection of topics or content items, rather than dynamic modification of the structure, length, explanation level, or stylistic parameters of the generated text. The absence of a closed feedback loop between detailed behavior logging, statistical analysis, and prompt construction restricts the system's ability to improve the relevance and usability of generated content over time. This results in inefficient utilization of compute resources on the server side, as redundant or unsuitable content continues to be generated.

Third, conventional systems rarely incorporate user emotional state, inferred from user interface interactions and fine-grained behavioral signals, as a first-class control variable in the generation process. When sentiment or affect is considered, it is often applied only in a post-processing filter or in a simplistic selection of pre-authored responses. The underlying prompt sentences for the generative AI model are not automatically adjusted to change the expression style or level of detail in direct response to detected emotional state. Consequently, the system cannot optimize the generative AI model's behavior at run time, which degrades the effectiveness of the model's computation and leads to unnecessary processing iterations.

Fourth, conventional architectures generally do not define a structured, programmatic pipeline in which a processor transforms raw behavior logs into structured data, computes user attribute profiles via statistical analysis, integrates these profiles with recent browsing histories and external information sources into explicit context information, and then encodes that context in a prompt sentence with machine-interpretable constraints on configuration format, explanation level, and output length. Without such a pipeline, the system cannot systematically control the generative AI model to generate content that is tightly aligned with computed user attributes and system-level constraints, which again causes inefficiencies in both server-side processing and network transmission.

Accordingly, there is a need for an improved computer-implemented system that configures a processor to (i) collect and structure user behavior information, (ii) perform statistical and contextual analysis to obtain user attribute information, (iii) construct rich prompt sentences that explicitly encode user attributes, histories, and presentation constraints, (iv) instruct a generative AI model using those prompt sentences, and (v) iteratively update both user attributes and prompt sentence content based on subsequent user interactions and emotional state. Such a system would improve the functioning of the computer by enabling more efficient use of processing, memory, and communication resources in generating and delivering customized information, rather than merely automating a human mental process or presenting abstract ideas.

The specific processing by the specific processing unit 290 of the data processing device 12 in Example 1 is realized by the following means.

The present invention provides a server comprising a processor configured to acquire user behavior information from a terminal, store the user behavior information as structured data in a storage device, perform statistical analysis processing on the stored user behavior information to generate attribute information indicating interests and preferences of a user, generate context information by integrating the attribute information, a natural language request sentence obtained from the user, browsing history of the user, and related information sources, generate a prompt sentence, based on the context information, for instructing a generative AI model in a generation processing apparatus to execute information generation processing, obtain custom information from the generative AI model by using the prompt sentence, provide the custom information to the terminal, acquire, as further user behavior information, a history of viewing, operating, and sharing of the custom information by the user, update the attribute information and content of the prompt sentence based on the further user behavior information so as to sequentially optimize information generation and provision methods for subsequent information provision, recognize an emotional state of the user based on user interface information or the user behavior information, and adjust the information generation and provision methods by changing an expression style or a level of detail in the prompt sentence in accordance with the emotional state. This enables the server to implement an improved, computer-centric feedback loop in which raw interaction data are transformed into structured behavioral profiles, the profiles are encoded into machine-interpretable prompt sentences that directly control operation of the generative AI model, and subsequent user reactions and emotional states are used to refine both the profiles and the prompt sentences, thereby enhancing computational efficiency, reducing unnecessary processing and communication, and improving the technical performance of personalized content generation and delivery.

The term “user behavior information” refers to data representing actions performed by a user via a terminal in relation to digital content, including at least viewing, operating, clicking, scrolling, and sharing, together with associated metadata such as timestamps, identifiers, and contextual parameters.

The term “terminal” refers to an information processing apparatus operated by a user, such as a client device or user interface device, that is configured to transmit user behavior information and natural language request sentences to a server and to receive and display custom information from the server.

The term “structured data” refers to data that are stored in a predetermined organization format suitable for machine processing, such as records, fields, and tables in a storage device, enabling querying, indexing, and analysis by a processor.

The term “storage device” refers to a hardware or virtualized resource configured to store structured data, including but not limited to main memory, persistent storage, databases, and data repositories accessible by the server.

The term “statistical analysis processing” refers to a set of computational operations performed on data, including aggregation, counting, averaging, weighting, and other numerical or categorical computations, in order to derive numerical indicators or structured metrics from raw user behavior information.

The term “attribute information” refers to data structures representing inferred properties of a user, including interests, preferences, and tendencies, that are derived from user behavior information by statistical analysis processing and are usable as control parameters for information generation.

The term “natural language request sentence” refers to a text input expressed in a natural language by a user, such as a query or instruction, that specifies a desired topic, content, or explanation to be generated by a generative AI model.

The term “browsing history of the user” refers to historical data indicating digital content accessed by the user, including identifiers of content items, access times, durations, and interaction types, which are stored as part of the user behavior information.

The term “related information sources” refers to information items, such as documents, records, or metadata, that are selected based on their relevance to the user's attribute information, browsing history, or request, and that are used as context for controlling the generative AI model.

The term “context information” refers to combined information generated by the processor by integrating attribute information, a natural language request sentence, browsing history of the user, and related information sources, and that is used as a basis for constructing a prompt sentence.

The term “prompt sentence” refers to a machine-interpretable natural language instruction sequence generated by the processor, which encodes context information, constraints, and control conditions, and is supplied as input to a generative AI model to direct its information generation processing.

The term “generative AI model” refers to a machine learning model configured to generate output content such as text based on input data including a prompt sentence, where the model produces new content by probabilistic or learned mapping rather than merely retrieving predefined content.

The term “generation processing apparatus” refers to an information processing component or system, which may be local or remote, that executes the generative AI model and performs computation to generate custom information in response to a prompt sentence.

The term “custom information” refers to information generated by the generative AI model in response to a prompt sentence, which is tailored to attribute information, context information, and user requests, and is provided to the user as personalized content.

The term “user interface information” refers to data representing states or changes of graphical or interactive elements presented to the user, including interaction patterns such as input speed, selection behavior, and interface usage, which are usable for inferring an emotional state.

The term “emotional state of the user” refers to an estimated affective condition of the user, such as interest, frustration, curiosity, or satisfaction, inferred by the processor based on user behavior information and/or user interface information.

The term “expression style” refers to characteristics of generated text, including tone, politeness level, formality, narrative style, and structural organization, that can be modified in a prompt sentence to adjust how information is presented.

The term “level of detail” refers to a degree of specificity or granularity in generated information, including factors such as explanation depth, technicality, and length, which can be controlled by conditions encoded in a prompt sentence.

The term “reaction history of the user” refers to user behavior information that specifically relates to custom information previously delivered to the user, including viewing durations, scroll depth, clicks, shares, likes, or dismissals, and that is used to refine attribute information and prompt sentences.

The term “configuration format of information” refers to a structural layout of generated content, such as use of sections, bullet lists, summaries, or stepwise explanations, which can be specified as constraints within a prompt sentence.

The term “output length” refers to a quantitative measure of the size of generated content, such as a number of words, characters, tokens, or sections, which can be constrained in a prompt sentence to limit or expand the generated result.

The term “information category” refers to a classification or topic label associated with information, such as a domain, subject area, or content type, which is selected based on the emotional state and attribute information and is used to control the generative AI model through the prompt sentence.

The term “tone of information” refers to stylistic and affective qualities of generated content, such as encouraging, neutral, cautionary, or explanatory tone, which the processor selects and encodes into the prompt sentence based on the emotional state of the user.

The term “type of information” refers to a functional kind of content to be generated, including overviews, detailed explanations, comparisons, recommendations, summaries, or step-by-step guides, which are specified in the prompt sentence to direct the generative AI model.

The term “priority of information” refers to an ordering importance assigned to different pieces or categories of information to be generated, which is encoded in the prompt sentence to influence which information is emphasized or generated first.

The term “presentation order of information” refers to a sequence in which different information elements are arranged and displayed in generated content, which the processor defines and describes in the prompt sentence to control the output structure of the generative AI model.

In one embodiment, a server provides a computer-implemented system for generating and delivering customized information using a generative AI model controlled by prompt sentences that are dynamically constructed from user behavior information and user emotional state. The server cooperates with one or more terminals operated by a user. The server, the terminal, and the user interact through a network, such as the Internet, using standard communication protocols.

The server includes at least one processor, a main memory, a non-volatile storage device, a network interface, and a database system. The server executes an operating system such as a general-purpose server operating system and an application framework that provides a web server function and an API function. The server uses a database management system such as a relational database management system to store user behavior information and attribute information. The server further uses a numerical computation library and a data analysis library, such as a matrix computation library and a tabular data processing library, to perform statistical analysis on user behavior information.

The terminal includes a processor, a memory, a display device, an input device, a network interface, and a storage device. The terminal executes an operating system such as a mobile operating system or a desktop operating system and runs a client application, such as a mobile application or a web browser, that presents an interface to the user. The terminal transmits user behavior information and a natural language request sentence to the server, and receives and displays custom information generated by the generative AI model.

The user operates the terminal by viewing content, scrolling, selecting controls, entering text, and sharing content. The terminal records these actions as user behavior information and transmits them to the server. The user also inputs natural language request sentences through a text input field or a voice input system that is converted to text. The user reads the custom information returned by the server and may perform further interactions, which are again recorded as user behavior information.

The server stores user behavior information as structured data. The server defines a data schema that includes, for example, a user identifier, a terminal identifier, a content identifier, an event type, timestamps, dwell time, scroll depth, click positions, and sharing destinations. The server stores these data as rows in one or more tables of the relational database. The server creates indexes on user identifiers, timestamps, and content identifiers, and uses table partitioning by time period to improve query performance. This structured storage enables the server to perform efficient statistical analysis and to retrieve user behavior information with low latency, thereby reducing processing time and improving scalability compared with unstructured logging.

The server performs statistical analysis processing on the stored user behavior information to generate attribute information indicating interests and preferences of the user. The server retrieves, for example, all events for a given user during a defined time window and loads them into memory as a tabular data structure. The server converts timestamps into a uniform time zone, filters out corrupted data (such as negative dwell times), and joins the user behavior information with content metadata, such as topic categories and tags. The server then computes, for each topic category, numerical metrics including view count, total dwell time, average dwell time, and a recency-weighted score calculated by applying an exponential decay function to older events. The server normalizes these metrics to form an interest vector for each user. The server stores these interest vectors as attribute information in a dedicated profile table or key-value store.

The server generates context information by integrating the attribute information, the natural language request sentence obtained from the user, the browsing history of the user, and related information sources. The server retrieves the most recent contents viewed or shared by the user, along with their categories and summaries. The server optionally computes vector representations of content items using an embedding model and searches a vector index to identify related information sources. The server aggregates these elements into a structured context that includes a list of top topics by interest score, summaries of key documents, and the user's current request. This context information is used as an intermediate representation between statistical analysis and natural language control of the generative AI model.

The server generates a prompt sentence for instructing the generative AI model based on the context information. The server uses a template that includes a role description of the generative AI model, a summary of user interests, a list of recent or representative articles, the natural language request sentence, and explicit constraints on structure, explanation level, and output length. The server performs string operations to fill the template with specific attribute values and context text and truncates or compresses sections if they exceed a predefined token budget. By encoding detailed, machine-interpretable constraints into the prompt sentence, the server directly controls the computational behavior of the generative AI model.

For example, the server generates a prompt sentence such as:
“You are a generative AI model acting as a personalized technology advisor.
User interests (estimated from behavior):
Artificial intelligence: very high interest
Smartphones: high interest
Smart home: moderate interest

Recent articles read and shared by the user:
1) Title: “Breakthroughs in Edge AI Chips for Smartphones” (Category: AI, Smartphones)
2) Title: “Next-Generation Smart Home Hubs” (Category: Smart Home, IoT)
User request: “Tell me about the latest developments in AI and smart home devices.”
Task: Based on the user's interests and recent behavior, generate a structured, easy-to-understand explanation of the latest developments in AI that impact smartphones and smart home devices. Focus on the last 12 months. Provide concrete examples and practical implications for everyday life. Keep the response under 800 words.”

In another example, the server generates a prompt sentence that explicitly reflects the user's preference for bullet points:
“You are a generative AI model. The user prefers concise bullet-point explanations.
User interests: data privacy (high), generative AI (high), consumer devices (medium).
User request: “Summarize recent news about generative AI and privacy.”
Task: Provide a bullet-point summary of major developments in generative AI and privacy over the last 6 months. Use short bullets (no more than two lines each), group related bullets under clear headings, and limit the total output to approximately 400 words.”

The server provides the prompt sentence to a generative AI model that may be implemented as a neural network-based language model. In one embodiment, the generative AI model is a transformer-based model that uses a multi-layer self-attention architecture, where each layer consists of attention heads, feed-forward sublayers, normalization operations, and residual connections. The model is trained on a large corpus of text data using an autoregressive training objective, such as minimizing a cross-entropy loss between predicted tokens and actual tokens in the training data. The model parameters (weights) are updated by an optimization algorithm such as stochastic gradient descent with momentum or an adaptive learning rate method. The model uses positional encoding to represent token order and can be further fine-tuned on domain-specific data to improve performance for technology-related content.

The server executes the generative AI model on dedicated hardware, such as a graphics processing unit or a tensor processing unit, that is optimized for matrix multiplications and parallel operations. The server encodes the prompt sentence into tokens using a subword tokenizer and feeds these tokens into the model. The model computes attention scores, hidden states, and output logits for each token and then generates new tokens according to a sampling strategy such as greedy decoding or top-k sampling. The server decodes the generated tokens into text to obtain the custom information.

The server does not simply “let the model decide” in an abstract manner. Instead, the server constrains the model by adjusting model parameters and decoding parameters based on the context. For instance, the server selects a temperature parameter, a maximum token length, and a probability threshold that depend on the user's attribute information and reaction history, thereby modifying the model's probabilistic behavior in a systematic, machine-controlled way. The server may reduce the temperature and limit maximum tokens for users who consistently prefer short, precise answers, leading to more deterministic outputs and reduced computation.

The server obtains the custom information generated by the generative AI model and provides it to the terminal. The server may transform the custom information into a structured response that includes a title, section headings, and body text. The server compresses or encodes the response to reduce network traffic when appropriate. The terminal receives the custom information, parses the response, and renders it in a graphical interface. The terminal may display sections separately, provide expandable areas for details, and track user interactions such as scroll position and click events.

The user reads the custom information and may scroll, click internal links, or share the content. The terminal logs these actions as user behavior information. For example, when the user spends a long time on a section about edge AI chips and ignores a section about smart home protocols, the terminal records corresponding dwell times and scroll positions. The terminal transmits this updated behavior information to the server.

The server acquires, as further user behavior information, the history of viewing, operating, and sharing of the custom information. The server tags these events with identifiers that link them to the specific generation instance and the prompt sentence used. The server incorporates this information into its statistical analysis. For example, the server increases the weight of topics that correspond to sections with high dwell time and decreases the weight of topics that correspond to skipped sections. The server updates the attribute information in the user profile, which in turn affects the selection of topics and explanation levels in subsequent prompt sentences.

The server recognizes an emotional state of the user based on user interface information and user behavior information. For example, the server may infer that rapid scrolling, repeated backtracking, and short dwell times on multiple answers indicate frustration or confusion.

The server may infer that prolonged viewing of certain sections or repeated viewing of similar content indicates curiosity or high interest. The server can implement these inferences as rule-based logic or as a classifier model trained on labeled interaction patterns. The classifier may be implemented as a neural network that takes numerical features such as scroll speed, click frequency, and dwell time distributions as input and outputs a probability distribution over emotional states. The server uses a loss function such as cross-entropy to train this classifier on annotated datasets, and updates model weights using gradient-based optimization.

When the server has recognized the emotional state, the server adjusts the expression style and level of detail in subsequent prompt sentences. For example, if the user appears confused, the server may add instructions such as “Use simpler language, define technical terms, and provide step-by-step explanations.” If the user appears bored, the server may add instructions such as “Provide a concise summary and focus on new, surprising aspects.” This direct modification of prompt sentences changes how the generative AI model allocates computation across tokens and topics, resulting in different text structures and lengths. By reducing unnecessary elaboration when the user prefers brevity, the server reduces the number of tokens generated, thereby reducing processing time and communication overhead.

The server thus implements a feedback loop that operates entirely within the computer system. The server transforms raw low-level event streams into structured behavior logs, computes high-level attributes through statistical analysis, converts these attributes into explicit text-level control signals in the prompt sentence, and then refines those attributes based on the user's reaction to generated outputs. This closed-loop mechanism improves the functioning of the computer system itself by minimizing redundant model invocations, reducing the generation of irrelevant or unused content, and improving cache utilization in the database through more predictable access patterns.

The server also improves data management by enforcing a specific data flow and module separation. The server uses separate modules for logging, analysis, profile management, prompt generation, model invocation, and response delivery. Intermediate data structures are defined so that each module receives and outputs well-typed data. For example, the analysis module outputs a fixed-length interest vector, and the prompt generation module interprets this interest vector using predetermined thresholds and mappings. This modularization and defined data structure design reduce error rates in data handling, facilitate parallelization of computations, and enable more efficient scaling across multiple machines.

The system is not limited to a single generative AI model. The server may maintain multiple models with different sizes or domains and may select a model based on the user attribute information and the complexity of the task. For example, the server may use a smaller, faster model for simple factual queries and a larger, more accurate model for complex explanatory requests. The server may determine a model selection rule that balances computational cost and expected benefit, resulting in further reduction of processing time and energy consumption. The server may also pre-compute and cache generic explanations for popular topics and then instruct the generative AI model to adapt these cached explanations to individual users via shorter prompts, thereby reducing the number of tokens that require full model inference.

In an alternative embodiment, the server uses additional features such as device type and network conditions to influence the prompt sentence. For example, when the terminal is a mobile device on a limited network connection, the server may instruct the generative AI model to generate shorter responses or to compress explanations. This control is implemented through explicit phrases in the prompt sentence, such as “Provide a brief explanation suitable for viewing on a mobile device with limited bandwidth.” By instructing the model in this way, the server reduces transmitted data volume and improves responsiveness on constrained devices.

In yet another embodiment, the server employs data augmentation and model fine-tuning techniques to improve the accuracy of user interest estimation and emotional state recognition. The server generates synthetic behavior patterns based on existing logs to expand the training data for the classifier model. The server uses regularization techniques and robust loss functions to reduce overfitting and improve generalization. These methods contribute to more reliable recognition of user states, which yields more appropriate adjustments in the prompt sentences and better alignment of generated content with user needs.

Overall, the server, the terminal, and the user cooperate in a technically specific architecture in which user behavior information is converted into structured data, statistically processed to derive attribute information, and encoded into prompt sentences that directly control a generative AI model at run time. This architecture yields concrete technical effects, including improved processing efficiency through reduced unnecessary generation, improved accuracy of personalization by using detailed behavioral and emotional features, improved data management through structured schemas and modular pipelines, and reduced communication overhead through adaptive control of output length and structure. The system therefore improves the operation of the computer itself, rather than merely implementing an abstract idea or automating a human mental process.

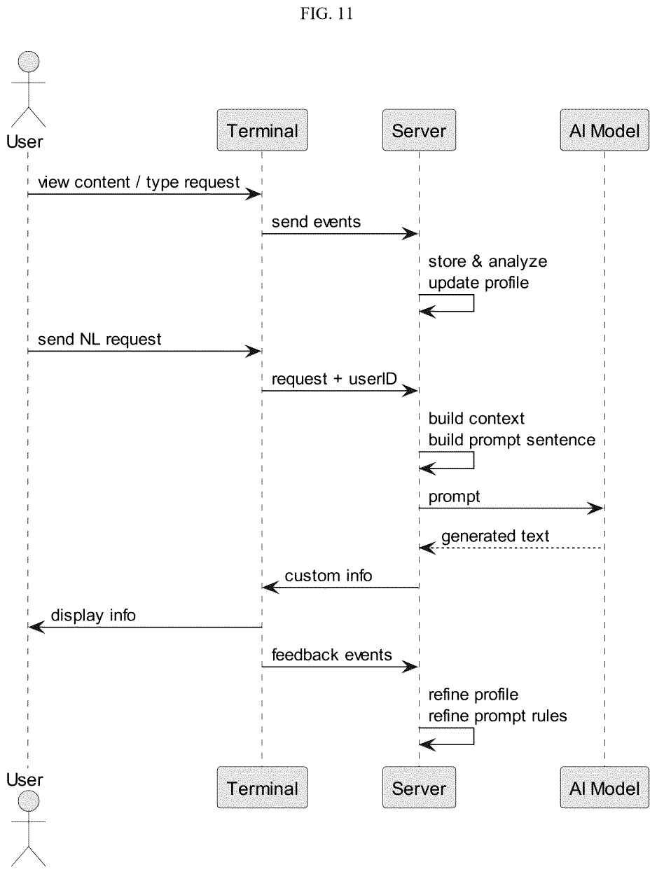

The following describes the processing flow using FIG. 11.

### Step 1:

The terminal records user interaction events and transmits user behavior information to the server.

The terminal receives as input low-level interaction signals such as touch events, scroll positions, key presses, and timestamps generated while the user views or operates content. The terminal converts these raw signals into structured event records including at least a user identifier, a content identifier, an event type (view, scroll, click, share), a start time, an end time, and a dwell time. The terminal packages multiple event records into a request payload, typically in a structured format, and sends the payload to the server via a network interface using a secure communication protocol. The output of this step is a stream of structured user behavior information delivered from the terminal to the server.

### Step 2:

The server receives the user behavior information and stores it as structured data in a storage device.

The server takes as input the event payload transmitted by the terminal. The server validates the payload, checks authentication tokens, verifies required fields, and discards or logs malformed entries. The server converts timestamp strings to a unified time zone, normalizes content identifiers and event types, and assigns a unique event identifier to each record. The server then performs data insertion into one or more tables in a database, such as a user events table, using database drivers and SQL commands. The output of this step is a set of stored event records organized as structured data, indexed by user, content, and time in the storage device.

### Step 3:

The server aggregates stored user behavior information to generate intermediate analytical data.

The server takes as input a subset of stored event records selected by user identifier and time window from the database. The server loads these records into an in-memory data structure, such as a tabular array, and performs data cleaning to remove records with missing or inconsistent values. The server groups the events by topic category, content identifier, and event type. The server computes basic metrics such as count of views per category, total dwell time per category, average dwell time per view, and frequency of shares. The server writes these aggregated metrics into an intermediate table or cache. The output of this step is analytical data that summarize user interactions by topic and behavior type.

### Step 4:

The server computes attribute information indicating user interests and preferences.

The server receives as input the aggregated analytical data from the previous step, including counts, dwell times, and share frequencies per topic. The server applies numerical operations such as normalization, weighting, and exponential decay to give more importance to recent events and to account for different interaction types. For example, the server multiplies share counts by a larger weight than view counts, and applies a time decay factor based on the age of each event. The server then normalizes the resulting scores to generate an interest vector, where each dimension represents a topic and each value represents a relative interest level between zero and one. The server stores this interest vector as attribute information in a user profile store. The output of this step is a structured attribute record that quantitatively represents the user's interests and preferences.

### Step 5:

The user submits a natural language request sentence through the terminal.

The terminal presents an input interface, such as a text box or chat window, to the user. The user provides as input a natural language request sentence, for example “Tell me about the latest developments in AI and smart home devices.” The terminal captures the text, associates it with the current user identifier and session information, and optionally validates that the length and character set are within acceptable limits. The terminal sends the validated request sentence to the server through an application programming interface. The output of this step is a request message containing the natural language request sentence and user-related metadata delivered to the server.

### Step 6:

The server constructs context information by integrating attribute information, browsing history, and related sources with the natural language request sentence.

The server receives as input the user's request message and retrieves the corresponding attribute information from the user profile store. The server also queries the database to obtain a portion of the user's browsing history, such as most recent viewed or shared content items and their associated topic categories and summaries. The server optionally accesses additional information sources, such as a document index or a vector-based similarity index, to select a small set of external documents or summaries that are closely related to the user's high-interest topics or to the request sentence. The server then compiles these elements into a structured context object that includes a list of top interest topics, selected browsing history entries, and selected related information sources, together with the original request sentence. The output of this step is a context information object that captures both user-specific and request-specific data for further processing.

### Step 7:

The server recognizes or updates an estimate of the user's emotional state based on user interface information and behavior information.

The server takes as input recent user behavior information, including data such as rapid scrolling, repeated request submissions, abrupt session termination, and dwell time distributions, as well as optional user interface state changes recorded by the terminal. The server computes numerical features, such as average scroll speed, number of rapid back-and-forth navigations, and the variance of dwell times across sections. The server feeds these features into an emotion recognition component, which may be implemented as a rule-based engine or as a classifier model. In the classifier case, the server runs the input feature vector through the classifier to obtain a probability distribution over emotional states such as confusion, high interest, or boredom. The server selects the most probable emotional state or a set of emotional states above a threshold and stores this estimate as part of the user's state information. The output of this step is an updated representation of the user's emotional state to be used in prompt construction.

### Step 8:

The server generates a prompt sentence for a generative AI model using the context information and the emotional state.

The server receives as input the context information object and the emotional state representation from previous steps. The server selects a prompt template according to system configuration and user preferences. The server fills placeholders in the template with concrete values, including top-interest topics, titles and short descriptions of recently viewed documents, summaries of related information sources, and the user's natural language request sentence. The server also encodes constraints derived from attribute information and emotional state, such as preferred output length, explanation level, and expression style. For example, if the user is estimated to be confused, the server adds instructions like “Use simple language and define technical terms.” The server concatenates all segments to form a single prompt sentence and performs token count estimation to ensure the text stays within predefined limits, truncating or summarizing parts if necessary. The output of this step is a completed prompt sentence that is ready to be supplied to the generative AI model.

### Step 9:

The server selects and invokes a generative ai model based on the task complexity and user profile.

The server takes as input the constructed prompt sentence and the user attribute information. The server applies a model selection policy that may consider factors such as required detail level, expected length, and computational cost. For a simple request, the server may choose a smaller, faster model; for a complex explanatory request, the server may choose a larger, more powerful model. The server encodes the prompt sentence into tokens using a tokenizer compatible with the chosen model and sets decoding parameters such as temperature, maximum tokens, and sampling strategy based on user preferences and historical response effectiveness. The server then sends the tokenized prompt and decoding parameters to the generative AI model, which may run on a specialized compute device or an external inference service. The output of this step is a sequence of generated tokens representing the custom information.

### Step 10:

The server post-processes the generated tokens to form structured custom information and sends it to the terminal.

The server receives as input the generated token sequence from the generative AI model. The server decodes the tokens into a text string and scans the text to detect section boundaries, headings, or bullet points, either by using markers in the text or by applying simple text analysis rules. The server may remove redundant or undesired segments, enforce maximum length by truncation, and, if necessary, add a short summary at the beginning. The server then encapsulates the resulting text and metadata such as generation time, topics, and source model identifier into a structured response. The server compresses the response if needed and transmits it via the network interface to the terminal. The output of this step is a structured custom information payload delivered to the terminal.

### Step 11:

The terminal receives the custom information and presents it to the user while monitoring further interactions.

The terminal takes as input the custom information payload received from the server. The terminal parses the payload, extracts the main text, headings, and any auxiliary metadata, and renders them on the display in a layout adapted to the screen size and interaction capabilities. The terminal may show headings as collapsible sections and may provide buttons for actions such as sharing or requesting more detail. As the user scrolls or interacts with the displayed content, the terminal records new interaction events, such as dwell time per section, scroll depth, and selection of interactive elements. The terminal stores these new events temporarily and prepares them to be sent again as user behavior information. The output of this step is a displayed customized content view and a new set of interaction logs to feed back to the server.

### Step 12:

The server updates the attribute information and future prompt sentence generation rules based on reactions to the custom information.

The server receives as input the new user behavior information that specifically relates to the displayed custom information, including viewing duration, scroll behavior, clicks, and shares.

The server identifies the generation instance associated with these interactions by using identifiers embedded in the payload. The server recalculates topic-specific metrics such as dwell time and engagement rate for the topics covered in the custom information and compares them to previous metrics. The server adjusts the weights in the user's interest vector accordingly, increasing weights for topics with high engagement and decreasing weights for ignored topics. The server also updates a record of presentation preferences, such as a tendency to favor short bullet lists over long paragraphs, based on which response formats led to higher engagement. The server incorporates these updates into the profile store and modifies the mapping logic that converts attribute information and emotional state into prompt sentence constraints. The output of this step is an updated set of attribute information and refined rules for future prompt sentence generation, which in turn influence subsequent invocations of the generative AI model.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional information recommendation systems typically rely on static rule-based filtering or simple collaborative filtering that operates on coarse user attributes and past selections. Such systems generally treat user behavior data as aggregated counters (for example, number of clicks per category) and do not construct a rich, machine-readable representation of a user's fine-grained interest profile. As a result, these systems are limited in their ability to generate dynamically tailored content and often provide recommendations that are only loosely aligned with the user's current informational needs.

Furthermore, existing systems that make use of generative artificial intelligence models commonly issue generic or manually crafted prompt sentences that do not fully exploit the structure and temporal evolution of user behavior data. In such arrangements, the generative artificial intelligence model is effectively decoupled from the underlying behavioral analytics pipeline, and therefore cannot adapt its output granularity, tone, or content selection in a principled and continuous manner based on the user's current context.

Additionally, known systems typically do not incorporate inferred emotional states of a user into the low-level control of prompt sentences supplied to a generative artificial intelligence model. While some approaches may attempt to detect user sentiment at a surface level, they rarely feed that information back into a closed-loop process that updates feature vectors, refines predictive models, and alters prompt parameters in real time. This results in an inability to adjust not only which information is presented but also how such information is linguistically framed, sequenced, and explained to the user.

From the perspective of computer technology, these limitations manifest as suboptimal utilization of computational resources and models. Behavior logs are stored but not transformed into feature vectors optimized for downstream generative processes; predictive models are executed but not tightly integrated with prompt generation; and generative models are invoked but not driven by a structured, machine-derived control signal. Consequently, the overall system architecture fails to provide an end-to-end pipeline in which behavioral data ingestion, statistical aggregation, feature vector construction, interest prediction, prompt sentence generation, and emotional-state-based adaptation are coherently orchestrated to improve the functioning of the computer system itself.

Therefore, there is a need for a computer-implemented system that (i) systematically converts raw behavior logs into structured feature vectors representing user interests, (ii) applies a predictive model to those feature vectors to generate fine-grained interest predictions, (iii) uses those predictions to automatically construct prompt sentences supplied to a generative artificial intelligence model, and (iv) closes the loop by incorporating user reactions and inferred emotional states to continuously optimize both the feature vectors and the prompt sentences. Such a system should improve the technical operation of the server-side processing pipeline, the efficiency and precision of generative model invocation, and the responsiveness of the system to changing user contexts.

The specific processing by the specific processing unit 290 of the data processing device 12 in Application Example 1 is realized by the following means.

The present invention provides a server comprising a processor configured to acquire behavioral information relating to information acquisition operations of a user, convert the behavioral information into a structured information format, and store the behavioral information in an information storage device; aggregate the behavioral information stored in the information storage device by executing statistical processing and feature extraction processing to generate, for each user, a feature vector representing a degree of interest in an information field; input the feature vector into a machine learning model to calculate a prediction result indicating an interest target and a degree of interest of the user; generate, on the basis of the prediction result and the behavioral information, a prompt sentence in a natural language that includes at least a user identifier, the interest target, the information field, an output condition, and an output format, and provide the prompt sentence as an input to a generative artificial intelligence model so as to cause the generative artificial intelligence model to generate personalized information; acquire the personalized information output from the generative artificial intelligence model, convert the personalized information into a format displayable on a user information processing terminal, and distribute the personalized information to the user information processing terminal; collect, as additional behavioral information, a reaction of the user to the personalized information on the basis of an operation history during information viewing, and update the feature vector and the prediction result so as to continuously optimize contents of the prompt sentence; and estimate an emotional state of the user on the basis of the behavioral information and reaction information to the generated information, and adjust a method of information generation and provision by the generative artificial intelligence model by changing, in the prompt sentence, at least one of the information field, an amount of information, a writing style, and a presentation order in accordance with the emotional state. This enables an integrated computer-implemented pipeline in which user behavior logs are transformed into optimized feature vectors, predictive models and generative artificial intelligence models are tightly coupled through dynamically constructed prompt sentences, and both user interest profiles and emotional states are exploited in a closed-loop manner to technically improve accuracy, adaptability, and efficiency of information generation and delivery by the server.

The term “behavioral information” refers to data representing one or more operations performed by a user in connection with acquisition, viewing, or interaction with information content, including, for example, identifiers of accessed content, timestamps, viewing durations, scroll operations, selection operations, and sharing operations.

The term “information acquisition operation” refers to an operation by which a user obtains or accesses information content via an information processing terminal, such as opening, viewing, scrolling, or selecting a content item.

The term “structured information format” refers to a machine-readable representation of data in which fields and their relationships are explicitly defined, such as a record format, a table format, or a hierarchical format, including, for example, key-value structures, tabular structures, or hierarchical object structures.

The term “information storage device” refers to a hardware component or subsystem capable of storing data under control of a processor, such as a magnetic storage device, a semiconductor storage device, or a combination thereof, including any associated data management software.

The term “statistical processing” refers to processing in which one or more statistical quantities, such as sums, counts, averages, distributions, or variances, are calculated from a plurality of data items.

The term “feature extraction processing” refers to processing in which one or more characteristic values are derived from raw data so as to represent properties of the data in a form suitable for input to a computational model, such as a machine learning model.

The term “feature vector” refers to an ordered set of numerical values representing one or more characteristics of a user's behavior, interests, or context in a form suitable for mathematical computation and input to a machine learning model.

The term “information field” refers to a category, topic, or classification associated with information content, such as a subject domain, a thematic area, or a content type.

The term “machine learning model” refers to a computational model that has parameters determined or adjusted through a data-driven training process, and that, when provided with input data such as a feature vector, outputs a prediction, classification, or other inferred value.

The term “prediction result” refers to output data produced by a machine learning model that indicates at least one inferred property of a user, such as an interest target or a degree of interest.

The term “interest target” refers to a topic, category, or attribute of information content that a user is predicted to be interested in, based on analysis of behavioral information.

The term “degree of interest” refers to a quantitative value, such as a score or probability, indicating an extent or strength of a user's predicted interest in an interest target or information field.

The term “prompt sentence” refers to a sequence of one or more natural language expressions supplied as input to a generative artificial intelligence model to instruct or condition the behavior of the generative artificial intelligence model.

The term “output condition” refers to one or more constraints or requirements specified for information to be generated by a generative artificial intelligence model, such as a quantity, length, style, or format of the generated information.

The term “output format” refers to a specified structural or presentational form in which information is to be generated or provided, such as a list, a summary, a narrative, or a structured data representation.

The term “generative artificial intelligence model” refers to a computational model that receives an input including a prompt sentence and automatically generates new information content, such as text, based on learned patterns from training data.

The term “personalized information” refers to information content that has been generated or selected on the basis of behavioral information, feature vectors, prediction results, or emotional states associated with a specific user.

The term “user information processing terminal” refers to an electronic device operated by a user and configured to receive, process, and present information content, such as a mobile terminal, a portable terminal, or a stationary terminal.

The term “operation history” refers to a chronological record of operations performed by a user with respect to information content or a user interface, including, for example, viewing operations, selection operations, and interaction operations.

The term “reaction” refers to a response of a user to information content, inferred or observed from the operation history, such as viewing duration, selection frequency, or sharing behavior.

The term “emotional state” refers to a state associated with a user's affect or sentiment, such as a positive, negative, or neutral state, inferred from behavioral information, reaction information, or other observable signals.

The term “writing style” refers to linguistic characteristics of text to be generated, such as tone, formality level, complexity, or narrative style.

The term “presentation order” refers to an arrangement of multiple items of information content, such as the sequence in which the items are output, displayed, or recommended to a user.

The term “provision timing” refers to a point in time or a time interval at which personalized information is sent or made available to a user.

The term “viewing time” refers to a time period during which information content remains displayed or accessible on a user information processing terminal in association with a viewing operation by a user.

The term “viewing frequency” refers to a number or rate of viewing operations associated with information content or an information field over a predetermined period.

The term “sharing frequency” refers to a number or rate at which a user initiates sharing operations for information content, such as distributing links or references to the content via a communication function.

The term “recommendation reason” refers to information that explains why particular information content has been generated, selected, or presented to a user, based on at least one of an interest target, a degree of interest, behavioral information, or an emotional state.

The term “summary information” refers to abbreviated content that conveys principal points of underlying information content using fewer words or a reduced amount of detail compared to the underlying information content.

The term “explanatory information” refers to content that provides additional clarification, context, or justification regarding generated information, recommendation results, or system behavior.

In one embodiment, a server, a terminal, and a network form a system configured to generate and deliver personalized information based on behavioral information and emotional states of a user. The server includes at least one processor, a main memory, and an information storage device. The terminal includes at least one processor, a display, an input interface, a communication interface, and a local storage. The server and the terminal communicate over a communication network such as a packet-switched network.

The server executes software components including a web server module, an application server module, a data processing module, a machine learning module, and a generative AI interface module. In one implementation, the server executes an operating system, a web server framework such as a generic HTTP server, and an application framework such as a general-purpose scripting framework. The server uses a database management system such as a relational database server to implement the information storage device. The data processing module uses a data analysis library, such as a numerical computation library or a data frame library, to perform statistical processing and feature extraction. The machine learning module uses a machine learning framework such as a tensor-based computation framework or a general deep learning framework to construct and execute a machine learning model and a generative AI model.

The terminal executes an operating system such as a mobile operating system or a desktop operating system, and an application program that communicates with the server. The terminal application records user operations, including content viewing, scrolling, selection, and sharing, as behavioral information and transmits the behavioral information to the server.

The terminal displays personalized information received from the server and records operation histories corresponding to reactions of the user to the personalized information.

The server stores behavioral information in the information storage device using a predetermined data structure. For example, the server stores each behavioral event as a record in a log table having fields including at least a user identifier, a content identifier, an information field identifier, a timestamp, a viewing duration, and one or more flags representing operations such as selection or sharing. The server indexes the user identifier and timestamp fields to enable efficient retrieval of event sequences for each user. The server periodically aggregates a plurality of records corresponding to each user and converts the aggregated data into a feature vector.

The server generates the feature vector by executing feature extraction processing. The server uses the data processing module to compute, for each information field, statistical quantities such as total viewing time, average viewing time per content item, viewing frequency, and sharing frequency. The server normalizes these quantities using techniques such as min-max normalization or z-score normalization. The server arranges the normalized quantities in a fixed order to form a numeric vector. The server may also encode temporal patterns, such as time-of-day viewing preferences, using cyclic encodings or histogram-based encodings, and append these encoded values to the feature vector. As a result, the feature vector represents, in a compact numeric form, characteristics of the user's interests and usage patterns.

The server inputs the feature vector into a machine learning model implemented by the machine learning module. In one embodiment, the machine learning model is a feed-forward neural network having an input layer, one or more hidden layers, and an output layer. The input layer receives the feature vector. Each hidden layer includes a plurality of units that apply a linear transformation followed by a non-linear activation function such as a rectified linear unit. The output layer produces a set of scores corresponding to interest targets or information fields. During a training phase, the server trains the neural network using historical behavioral information and known target labels representing user interest outcomes, such as click-through of recommended content or long viewing durations. The server computes a loss value using an error function such as cross-entropy loss or mean squared error, and updates the weights of the neural network using an optimization algorithm such as stochastic gradient descent or a variant thereof. The server may use regularization techniques and data augmentation, for example by slightly perturbing viewing durations or sampling sub-sequences of behavior histories, to improve generalization. By performing these computations on the server, the system improves prediction accuracy and reduces the need for manual rule design.

At runtime, the server executes only the forward propagation of the trained neural network. The server obtains a prediction result that indicates, for each interest target, a degree of interest of the user. Because the prediction result is computed from multiple statistical features and temporal patterns, the server can detect subtle shifts in interests that would be difficult to identify through simple rule-based processing. This improves the technical performance of the recommendation pipeline, including faster adaptation to new behavior and higher precision in selecting relevant information fields.

The server uses the prediction result and the underlying behavioral information to construct a prompt sentence for a generative AI model. The server executes a prompt generation module implemented in the application server. The prompt generation module formats the prompt sentence as a structured natural language text that includes at least a user identifier, interest targets with scores, descriptions of recent behavioral information, and explicit instructions for content, style, and format of the output. For example, the server may generate a prompt sentence such as:
“You are a content personalization engine.
User ID: 12345
Predicted interests: Technology 0.93, Artificial Intelligence 0.90, Cloud Computing 0.82, Finance 0.60, Entertainment 0.25.
Recent behavior: The user reads long-form AI and cloud computing articles, and frequently shares AI ethics content.

Task:
1) Generate a personalized list of 5 technology and AI-related news items that this user is likely to find engaging.
2) For each item, provide a title, a short description (under 100 words), and a one-sentence explanation of why it matches the user's interests.
3) Use a professional but accessible tone suitable for a tech-savvy reader.”

The server passes the prompt sentence to the generative AI model via the generative AI interface module. In one implementation, the generative AI model is a transformer-based neural network, such as a sequence-to-sequence language model, deployed either locally on the server or on a connected computation service. The transformer-based model includes multiple attention layers that compute contextual relationships between tokens in the prompt sentence and already generated tokens. The server supplies the prompt sentence as a sequence of token identifiers, and the model generates output tokens according to a probability distribution computed by the attention-based architecture. The server controls generation parameters such as temperature and maximum token length to balance diversity and determinism of the generated content.

The server receives the output text from the generative AI model, parses the text according to the expected structure specified in the prompt sentence, and converts the text into a data structure containing, for example, a list of items each including a title, a summary, and a recommendation reason. The server associates each generated item with real content records stored in the information storage device. To achieve this, the server executes keyword matching, embedding-based similarity search, or other content retrieval algorithms to map descriptive phrases in the generated text to content identifiers. This technical linkage between generated text and stored content enables the server to present actual, accessible items rather than purely synthetic descriptions.

The server further estimates an emotional state of the user. In one embodiment, the server uses an auxiliary classification model implemented as a neural network that receives features derived from behavioral information, such as abrupt changes in viewing time, avoidance of certain topics, or reactions to prior personalized information. The server may also use sentiment scores computed from user-generated text, if available. The server outputs an emotional state label, such as positive, neutral, or negative, or a continuous value representing an affect score. The server uses this emotional state information to adjust parameters of the prompt sentence, for instance by instructing the generative AI model to simplify explanations when the user appears confused, or to reduce the volume of information when the user appears overloaded.

For example, in response to a negative emotional state, the server may generate a prompt sentence such as:
“You are a personalization assistant.
The user currently shows signs of overload and frustration.
User ID: 12345
Predicted interests: Technology (high), Artificial Intelligence (high), Cloud Computing (medium).

Task:
1) Generate 3 concise and easy-to-understand explanations (each under 60 words) summarizing the most important AI-related news for today.
2) Use a calm and supportive tone.
3) Avoid technical jargon where possible.”

By embedding such specific control instructions in the prompt sentence, the server uses the generative AI model in a non-generic manner that is tightly integrated with the predictive modeling and behavioral analytics pipeline. This integration improves the technical operation of the system by reducing unnecessary token generation, lowering communication bandwidth when using an external generative AI endpoint, and decreasing latency in serving personalized responses.

The terminal receives the personalized information from the server in a structured representation. The terminal converts the representation into a display layout using a rendering engine. The terminal may reorder items according to a priority score provided by the server, and may adapt the visual emphasis of items in accordance with metadata derived from the prediction results and emotional state estimates. The terminal records user reactions such as selection, scrolling depth, and dwell time, and transmits condensed summaries of these reactions to the server. By transmitting only derived metrics (for example, aggregated viewing time per item) instead of raw interaction logs, the system can reduce communication load without sacrificing modeling accuracy.

The server updates the feature vector and prediction result based on newly received behavioral information. The server may employ an incremental learning scheme, where the machine learning model parameters are fine-tuned periodically using recent data, or an online updating scheme, where a separate lightweight model updates interest estimates in real time while the main model is retrained offline. Consequently, the server maintains a current representation of user interests with minimal delay and computational overhead, which improves the responsiveness and accuracy of subsequent prompt sentences and generative outputs.

The described architecture and data flow differ from mere automation of human tasks. The server does not simply mimic human decision-making; instead, the server constructs high-dimensional feature vectors that encode statistical, temporal, and structural patterns in behavioral information, applies non-linear transformations via multi-layer neural networks trained on large datasets, and generates machine-optimized prompt sentences that a human would not practically design at the same scale or speed. The use of specific neural network architectures, feature encodings, and prompt control rules allows the computer system to process large volumes of data more efficiently and with higher precision than conventional rule-based or manual approaches.

In another embodiment, the server uses a mixture-of-experts architecture for the machine learning model, where different sub-networks handle different information fields or temporal patterns. The server computes a gating function to select or weight the outputs of the sub-networks depending on the current feature vector. This configuration can further improve accuracy and computational efficiency by focusing resources on relevant portions of the model. In yet another embodiment, the server employs a recurrent neural network or a transformer encoder to handle sequences of events explicitly, thereby capturing ordering and interval information between user actions.

In a further embodiment, the generative AI model may be fine-tuned using logs of previously successful personalized outputs and corresponding user reactions. The server defines a reward function that increases when users exhibit favorable reactions, such as extended viewing durations or positive feedback signals. The server then adjusts the generative model parameters or the prompt generation rules to maximize the reward, creating a feedback loop that improves generation quality and computational efficiency over time.

The system can be applied to various information domains, such as news delivery, educational content recommendation, technical documentation assistance, or media library navigation. In each use case, the same technical principles apply: the server converts raw behavioral information into feature vectors, the server executes machine learning and generative models under precise control via prompt sentences, and the server uses emotional state estimation to adjust information generation and presentation. This results in a concrete improvement of computer technology in terms of prediction accuracy, processing speed, resource utilization, and adaptability of information delivery in a networked computing environment.

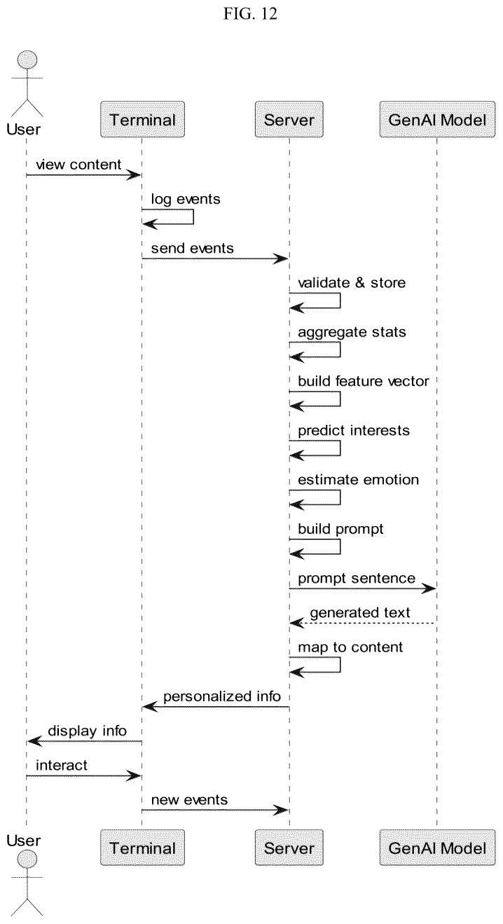

The following describes the processing flow using FIG. 12.

### Step 1:

The terminal records behavioral information of the user.

The terminal receives input in the form of user operations, such as opening content, scrolling, pausing on a screen, selecting an item, or activating a share function.

The terminal processes the input by assigning each operation a timestamp, associating it with a user identifier and a content identifier, and measuring viewing duration using an internal timer.

The terminal outputs structured behavioral events, for example records including fields such as user ID, content ID, category, start time, end time, scroll depth, and share flag, and temporarily stores these records in a local buffer.

### Step 2:

The terminal transmits the behavioral information to the server.

The terminal receives input in the form of buffered behavioral event records.

The terminal processes the input by packaging multiple event records into a structured message, attaching an authentication token, and serializing the message into a structured text format suitable for network transmission.

The terminal outputs a network request containing the packed behavioral information and sends the request to a logging endpoint provided by the server.

### Step 3:

The server ingests and validates the behavioral information.

The server receives input in the form of the network request containing serialized behavioral events.

The server processes the input by decoding the serialized data, verifying authentication credentials, checking that required fields such as user ID, content ID, and timestamps are present, and confirming that numeric values such as viewing duration and scroll depth are within expected ranges.

The server outputs a set of validated behavioral event records and a set of rejected records, and stores log information for rejected records for later diagnosis.

### Step 4:

The server stores the validated behavioral information in an information storage device.

The server receives input in the form of validated behavioral event records.

The server processes the input by mapping each record field to corresponding columns of a log table, executing insertion operations into a relational data structure, and updating indexes on user identifiers and timestamps to maintain efficient query performance.

The server outputs persistent log entries in the information storage device, making the behavioral information available for later aggregation and analysis.

### Step 5:

The server aggregates behavioral information and constructs base statistics.

The server receives input in the form of log entries retrieved from the information storage device for a given user over a specified time window.

The server processes the input by grouping the entries by information field or topic, summing viewing durations, counting views and shares, computing averages per content item, and optionally filtering out events shorter than a threshold viewing duration.

The server outputs aggregated statistics per user and per information field, such as total viewing time, viewing frequency, and sharing frequency.

### Step 6:

The server generates a feature vector representing user interests.

The server receives input in the form of aggregated statistics for each information field and optional temporal patterns, such as distribution of activity across hours of the day.

The server processes the input by normalizing numeric values using a normalization function, encoding categorical information such as information fields into fixed positions, and concatenating the normalized values into a single ordered numeric array.

The server outputs a feature vector for the user, where each element of the vector quantitatively represents a particular aspect of the user's behavior or preference.

### Step 7:

The server predicts an interest profile using a machine learning model.

The server receives input in the form of the feature vector generated for the user.

The server processes the input by feeding the feature vector into a trained neural network, performing matrix multiplications and activation functions layer by layer, and computing output scores that correspond to predicted degrees of interest in respective interest targets.

The server outputs a prediction result, such as a list of interest targets with associated interest scores, and stores or caches this result for prompt generation.

### Step 8:

The server estimates an emotional state of the user.

The server receives input in the form of recent behavioral information and reaction data to previous personalized information, such as changes in viewing duration or abrupt abandonment of certain content.

The server processes the input by applying an emotional-state estimation model, for example a classifier that takes numerical features extracted from these behaviors, calculates weighted sums and activation outputs, and assigns an emotional category or a continuous affect score.

The server outputs an estimated emotional state label or score and associates this value with the corresponding user identifier.

### Step 9:

The server constructs a prompt sentence for a generative AI model.

The server receives input in the form of the prediction result, the feature vector, recent behavioral summaries, and the estimated emotional state.

The server processes the input by selecting relevant interest targets, determining constraints such as number of items and length limits, adjusting style and tone parameters based on the emotional state, and concatenating these elements into a coherent natural-language instruction.

The server outputs a prompt sentence that includes the user identifier, interest targets and scores, behavioral descriptions, emotional context, and explicit instructions regarding content type, output length, style, and structure.

### Step 10:

The server invokes the generative AI model using the prompt sentence.

The server receives input in the form of the constructed prompt sentence and generation parameters such as maximum token count and diversity controls.

The server processes the input by transforming the prompt sentence into a sequence of tokens, passing the token sequence through a generative model such as a transformer-based language model, and iteratively computing probability distributions over next tokens to generate output text.

The server outputs generated text that conforms to the instructions in the prompt sentence, such as a set of personalized item descriptions and explanations.

### Step 11:

The server post-processes the generated text and links it to stored content.

The server receives input in the form of the generated text produced by the generative AI model.

The server processes the input by parsing the text into separate items according to the expected structure, extracting titles, summaries, and recommendation reasons, and performing text matching or embedding-based similarity calculations to associate each item with one or more concrete content records stored in the information storage device.

The server outputs a list of personalized information items, each including a reference to actual stored content, generated descriptive text, and metadata such as relevance scores or priority levels.

### Step 12:

The server prepares a response payload for the terminal.

The server receives input in the form of the list of personalized information items for the user.

The server processes the input by organizing the items into an ordered collection based on priority, formatting the collection into a structured response format, and attaching timestamps and identifiers for tracking.

The server outputs a response payload that contains all information necessary for the terminal to render the personalized information, and transmits this payload to the terminal over the network.

### Step 13:

The terminal renders the personalized information to the user.

The terminal receives input in the form of the response payload from the server.

The terminal processes the input by parsing the structured representation, mapping each item to visual components such as title text, summary text, and thumbnail images, and arranging the items in a display area according to the specified order and metadata.

The terminal outputs a rendered user interface that displays the personalized information, and waits for new user operations such as taps, scrolls, or dismissals, which become new behavioral information.

### Step 14:

The user interacts with the personalized information.

The user receives input in the form of the rendered personalized information on the terminal display.

The user processes the input by performing actions such as selecting items of interest, ignoring or dismissing less relevant items, and optionally using interaction functions such as sharing or saving.

The user outputs observable behavior that is captured as new behavioral events by the terminal, thereby providing updated input for subsequent processing cycles of the server.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional information delivery systems generally rely on static recommendation rules or simple collaborative filtering based on coarse user profiles. Such systems are typically configured to select content items from a content repository and present them to a user without dynamically adapting the form and substance of the content itself. As a result, when the volume and diversity of available digital content increase, the systems tend to exhibit degraded performance in terms of relevance, user engagement, and efficient utilization of computing resources. In particular, these systems often transmit large, unpersonalized payloads to user terminals, causing unnecessary network traffic and processing load on both server and client devices.

In addition, known systems usually treat user behavior information and user emotional states as separate or static parameters, if they consider emotional states at all. They do not tightly integrate fine-grained, time-series behavior signals and inferred emotional states into the core control logic of content generation. Consequently, they lack a feedback mechanism that can continuously reconfigure how a generative AI model is prompted, how content is structured, and how content is presented, in response to evolving user interests and emotional reactions. This leads to suboptimal use of generative AI resources, including redundant model invocations, generation of excessively long or irrelevant text, and increased latency.

Further, typical server-side architectures invoke generative AI models with generic prompt templates that are not systematically optimized based on user-specific reaction tendencies. The prompt sentences supplied to the generative AI model often fail to encode granular instructions regarding content category, length, style, and emphasis derived from prior user interactions. This reduces the effectiveness of the generative AI engine as a computing component, resulting in wasted computation on content that is unlikely to be consumed or appreciated by the user and impairing overall system throughput.

Accordingly, there is a need for an improved computer-implemented system and method that: (i) jointly analyzes user behavior information, interest information, and inferred emotional states; (ii) dynamically generates and updates prompt sentences for a generative AI model; (iii) structurally transforms model output into optimized information content; and (iv) uses the resulting reaction feedback as a control signal to adapt subsequent server-side processing. Such a system should improve the technical performance of the information delivery pipeline, including reduced network overhead, more efficient utilization of generative AI computations, lower latency, and improved alignment between generated content and user behavior patterns.

The specific processing by the specific processing unit 290 of the data processing device 12 in Example 2 is realized by the following means.

The present invention provides a server comprising a processor configured to collect user behavior information including information acquisition history and interest information from one or more user terminals, estimate a user interest field based on the collected behavior information and interest information, select at least one information classification corresponding to the estimated user interest field, generate a prompt sentence including instruction content for summarizing or reconstructing source information acquired from an information source based on the selected information classification and for instructing generation of custom information by a generative AI model, input the prompt sentence and the source information to the generative AI model to cause the generative AI model to generate text information optimized for each user, structure the generated text information into information content including heading information, summary information, and body information, convert the information content into distribution data for a user terminal, transmit the distribution data to the user terminal, collect additional behavior information and reaction information relating to presentation of the information content at the user terminal, estimate an emotional state of the user based on the behavior information and the reaction information, and dynamically adjust at least one of the instruction content of the prompt sentence, a selection of the information classification, and a presentation format of the information content in accordance with the emotional state and the user interest field. This enables the server to operate as an adaptive control unit for the generative AI model and the content delivery pipeline, thereby reducing unnecessary data transfer, optimizing computational load on the generative AI model, shortening response time, and improving alignment between generated content and user-specific interaction patterns, which results in an overall improvement of computer system performance in personalized information generation and distribution.

The term “user behavior information” refers to information indicating actions performed by a user in relation to digital content, including but not limited to content selection, viewing history, interaction frequency, dwell time, scrolling behavior, and response operations at a user terminal.

The term “information acquisition history” refers to a subset of user behavior information that records which content items a user has accessed, when the user accessed the items, and in what sequence the items were accessed.

The term “interest information” refers to information representing declared or inferred preferences of a user, including preferred topics, categories, or content types, which may be obtained from explicit user input or derived from user behavior information.

The term “user interest field” refers to one or more topics, themes, or categories for which a user exhibits a relatively high level of interest, as estimated based on the user behavior information and the interest information.

The term “information classification” refers to a category, subcategory, or other classification label used to group and organize content items according to subject matter, topic, or theme.

The term “information source” refers to any storage unit, repository, or external service from which source information such as raw text, articles, or data records can be acquired for processing and content generation.

The term “source information” refers to raw or pre-existing information obtained from an information source, including text data, metadata, and other structured or unstructured data used as input for content generation or summarization.

The term “prompt sentence” refers to a text string or sequence of text tokens that encodes instructions and conditions for a generative AI model, including at least one of desired topic, information classification, length, style, structure, or emphasis of output content.

The term “generative AI model” refers to a generative information processing unit implemented in hardware and/or software that receives a prompt sentence and optional source information as input and generates new text information or other content based on learned parameters.

The term “text information” refers to machine-readable textual data generated by the generative AI model, including sentences, paragraphs, and structured text segments suitable for presentation to a user.

The term “information content” refers to structured text information formatted for delivery to a user, including at least heading information, summary information, body information, and optionally associated metadata such as category or timestamp.

The term “heading information” refers to a text segment that serves as a title, headline, or main label for corresponding information content.

The term “summary information” refers to a condensed text segment that captures key points or an outline of corresponding body information in a shorter form.

The term “body information” refers to a main text segment providing detailed explanation, description, or narrative content corresponding to a heading and a summary.

The term “distribution data” refers to data formatted for transmission from a server to a user terminal, the data including at least information content and associated metadata suitable for display or notification at the user terminal.

The term “user terminal” refers to an information processing device operated by a user, such as a mobile device, a personal computer, or a tablet, that is configured to receive, display, and allow interaction with distribution data.

The term “notification function” refers to a function of a user terminal or an associated software component that presents alerts, banners, messages, or similar notifications to inform a user of new or updated information content.

The term “display function” refers to a function of a user terminal or an associated software component that renders information content on a visual display for viewing and interaction by a user.

The term “reaction information” refers to information indicating how a user responds to presented information content, including at least one of viewing duration, scrolling behavior, selection operations, like or bookmark operations, share operations, or dismissal operations.

The term “emotional state” refers to an inferred state of a user's affective condition, such as positive, neutral, or negative, estimated based on behavior information, reaction information, and optionally additional signals.

The term “reaction tendency” refers to a pattern or trend derived from time-series user behavior information and reaction information, indicating how a user tends to respond to particular types of information content over time.

The term “writing style” refers to characteristics of generated text, including at least one of tone, formality level, narrative style, sentence length, or structural organization, which can be controlled via the prompt sentence.

The term “weight information” refers to numerical or logical values associated with possible information classifications or emotional states, used to calculate a priority or selection probability of each information classification.

The term “priority” refers to a relative ranking or importance value assigned to each of a plurality of information classifications, calculated based on weight information and used to select at least one information classification for content generation.

The term “presentation format” refers to a manner in which information content is presented at a user terminal, including at least one of layout, ordering, emphasis, font size, and choice between notification-based presentation and in-application display.

In one embodiment, a server, one or more terminals, and one or more users cooperate to implement the claimed system. The server includes at least one processor, a main memory, a non-volatile storage unit, and a network interface. The processor may be a general-purpose central processing unit such as an x86-64 processor, and optionally one or more graphics processing units for accelerating inference of a generative AI model. The memory stores executable instructions and data structures implementing the functions described below. The non-volatile storage unit stores user behavior information, interest information, source information, and generated information content. The network interface connects the server to a communication network such as the Internet using standard communication protocols.

The server executes an operating system such as a general-purpose server operating system and executes an application program that implements an information delivery service. The server uses a database management system, such as a relational database system, to store user profiles, behavior logs, interest profiles, and generated content. In some embodiments, the server uses a search engine index to store and retrieve source information, such as news articles or text documents. The server further uses a natural language processing library to perform tokenization, part-of-speech tagging, keyword extraction, and other linguistic preprocessing on text data.

The server uses a generative AI model as a generative information processing apparatus. In one embodiment, the generative AI model is a transformer-based neural network that has been pre-trained on a large corpus of text data and then fine-tuned on domain-specific content. The model comprises a plurality of layers, each layer including a multi-head self-attention mechanism and a feedforward network with non-linear activation functions. The model stores learned parameters in the form of weight matrices and bias vectors. The server stores the model parameters in memory and performs forward propagation operations to generate text information based on an input prompt sentence and optionally additional source information.

The server represents user behavior information as structured records. Each record may include a user identifier, a content identifier, a timestamp, an information classification label, a dwell time value, a scroll depth value, and an interaction type such as open, close, like, bookmark, or share. The server stores these records in a behavior log table in the database. The server aggregates user behavior information over time to form time-series data for each user. The server also stores interest information, such as explicit category preferences selected by a user at a terminal, in a separate profile table.

The terminal is an information processing device operated by a user. The terminal may be a mobile device, a tablet, or a personal computer. The terminal includes a display unit, an input unit such as a touch screen or keyboard, a memory, a processor, and a communication interface. The terminal executes an application, such as a news viewing application or a web browser, configured to communicate with the server over the network. The terminal records local interaction events, including content selection, scrolling, and button presses, and transmits corresponding behavior information to the server in a structured format using network requests.

The user operates the terminal to view information content, to select topics of interest, and to react to content by actions such as liking, bookmarking, or sharing. The user's operations cause the terminal to generate behavior information. The user may explicitly input interest information, such as selecting favorite topics from a list of information classifications. The user may also implicitly express interest through repeated access to particular categories of content.

The server performs data processing and data operations to estimate a user interest field. The server retrieves behavior information and interest information for each user from the database. The server computes, for each information classification, a score indicating the user's level of interest. The score may be computed by aggregating dwell time, frequency of access, and recency of access using a weighted sum. The server may apply an exponential decay function to reduce the influence of older events. As a result, the server maintains a vector of interest scores for each user, where each element corresponds to an information classification. The server defines the user interest field as the subset of classifications whose scores exceed a threshold or rank among the top values.

The server also estimates an emotional state of the user. The server may derive reaction information, such as abrupt abandonment of content, frequent dismissals of notifications, or high engagement metrics, from behavior information. The server may use a classifier model, such as a shallow neural network or a logistic regression model, that maps features derived from reaction information to an emotional state label, such as positive, neutral, or negative. The features may include normalized dwell time, scroll velocity, ratio of likes to views, and frequency of content dismissals. The server stores the emotional state as a time-varying field in the user profile.

The server selects an information classification based on the user interest field and the emotional state. The server may assign weights to different classifications for each emotional state, and compute a priority value by multiplying the interest score by a weight corresponding to the current emotional state. The server sorts the classifications by priority and chooses one or more top classifications as target classifications for generating new content.

The server acquires source information from an information source. In one embodiment, the server issues search queries to a content index, specifying the chosen information classification and optional keywords. The server receives a set of documents, each document including a title, a body, metadata, and an information classification. The server may truncate or extract portions of the documents to be used as source information for summarization or rewriting by the generative AI model. The server stores the source information in a temporary buffer in memory.

The server constructs a prompt sentence for the generative AI model. The server uses a prompt generation module that combines templates and dynamic parameters. The templates may define a structure such as an instruction segment, a context segment, and an output constraint segment. The dynamic parameters may include the user interest field, the selected information classification, the target emotional tone, the desired output length, and the desired writing style. The server generates a prompt sentence that instructs the generative AI model to generate custom information tailored to the user.

For example, the server may generate the following prompt sentence:
“Based on the following recent sports news articles, generate a coherent news article tailored to a user who is very interested in soccer. Summarize the key match results, highlight important players, and explain the significance of the matches in the league standings. Use clear and engaging language suitable for a general audience.”

In another example, the server may generate the following prompt sentence:
“The user consistently reads articles about artificial intelligence and startups. Generate a detailed yet easy-to-understand article explaining a recent breakthrough in AI technology and how it may affect startup companies. Use an informative and neutral tone.”

In a further example, the server may generate the following prompt sentence:
“For a user who follows the team ‘FC Example United,’ generate an in-depth match report of the team's latest game. Describe the final score, goal scorers, tactical changes, and what this result means for the rest of the season.”

The server inputs the prompt sentence and the source information to the generative AI model. In one embodiment, the server concatenates the prompt sentence with a representation of the source information, such as a list of headings and key points, into a single text sequence. The server encodes the sequence into tokens and feeds the tokens to the input layer of the transformer-based generative AI model. The model performs multiple layers of self-attention and feedforward operations, using learned parameters to compute output token probabilities. The server samples or decodes tokens based on these probabilities, for example using a greedy or beam search decoding algorithm, to generate text information that forms the body of custom information.

The server structures the generated text information into information content. The server may parse the generated text to identify a heading sentence, a summary paragraph, and a body section based on delimiters or template constraints specified in the prompt sentence. The server then constructs a data record that includes heading information, summary information, body information, and metadata such as the information classification and a timestamp. The server stores this information content in the database and also converts it into distribution data, which may be a structured message or a serialized object, for transmission to a terminal.

The terminal receives the distribution data from the server via the communication interface. The terminal parses the distribution data, extracts the heading information, summary information, and body information, and renders these components on the display unit using a user interface framework. The terminal uses a notification function to present alerts or banners, such as “New soccer news for you,” based on received distribution data. When the user selects a notification, the terminal displays the full body information in an application screen. The terminal measures the user's reaction to the content, such as dwell time and scrolling depth, and sends updated behavior information and reaction information back to the server.

The server uses this feedback to refine subsequent prompt sentences. The server aggregates time-series behavior information and reaction information to estimate a reaction tendency. The server may compute, for each combination of information classification and writing style, a response score that reflects how the user responds to such content. The server then modifies parameters used in prompt generation, such as requested text length or style, so that the generative AI model produces content more aligned with the user's response patterns. By adjusting the prompt sentence based on reaction tendency, the server reduces generation of unnecessary or unwanted text, thereby decreasing computational load and latency.

The server thus operates as an adaptive control unit for the generative AI model and the content delivery pipeline. The server performs technical data processing operations, such as time-series aggregation, priority computation, and parameter adjustment, that are specifically tailored to controlling a high-parameter neural network model and a distributed content delivery architecture. The server's control logic is not limited to merely automating human editorial judgment; instead, it directly manages how tokens are fed into the generative AI model, how model outputs are truncated or structured, and how often the model is invoked. As a result, the system reduces redundant model calls, avoids generating excessively long content that may never be viewed, and optimizes resource utilization of processing units and memory.

In one embodiment, the server stores user interest profiles and emotional state estimates in compact vector formats, and updates these vectors using incremental algorithms. This design reduces database write operations and accelerates read operations when constructing prompt sentences. The server may also batch multiple prompt generation and model inference tasks, reusing shared source information across users with similar interest fields, to further reduce redundant data retrieval and network traffic.

In another embodiment, the server deploys the generative AI model on a dedicated accelerator device and adjusts batch sizes and sequence lengths according to current system load and user-specific needs inferred from behavior information. By dynamically adapting sequence length (for example, by shortening prompts for users who prefer concise content), the server reduces the number of operations performed by the neural network layers and achieves lower inference latency and power consumption.

In a further embodiment, the server utilizes different generative AI models or different model configurations depending on the estimated emotional state. For example, the server may select a smaller model configuration to generate shorter, more neutral updates when the emotional state suggests low engagement, while selecting a larger model configuration to generate more detailed analytical content for users with high engagement in a certain information classification. This selection is controlled by explicit logic implemented in the server and coordinated with the prompt generation module, thereby improving computational efficiency at the system level.

The server and terminal combination provide technical effects beyond abstract data manipulation. The server reduces communication load by transmitting already-structured information content rather than large raw document sets to the terminal. The server improves storage management by storing behavior information and interest profiles in normalized structures and by pruning obsolete behavior records based on defined policies. The generative AI model is controlled to generate text at a granularity that matches the display capabilities of the terminal, reducing memory consumption and rendering time at the terminal.

The user thus experiences timely, relevant, and appropriately sized information content, while the underlying computer system achieves improved processing speed, improved utilization of hardware resources, reduced error in relevance estimation, and reduced network traffic. The described embodiments present specific data structures, algorithms, and model control methods that enable others skilled in the art to implement the invention and adapt it to various application contexts, such as news delivery, educational content generation, or personalized reports, while maintaining the same underlying technical improvements to computer operation.

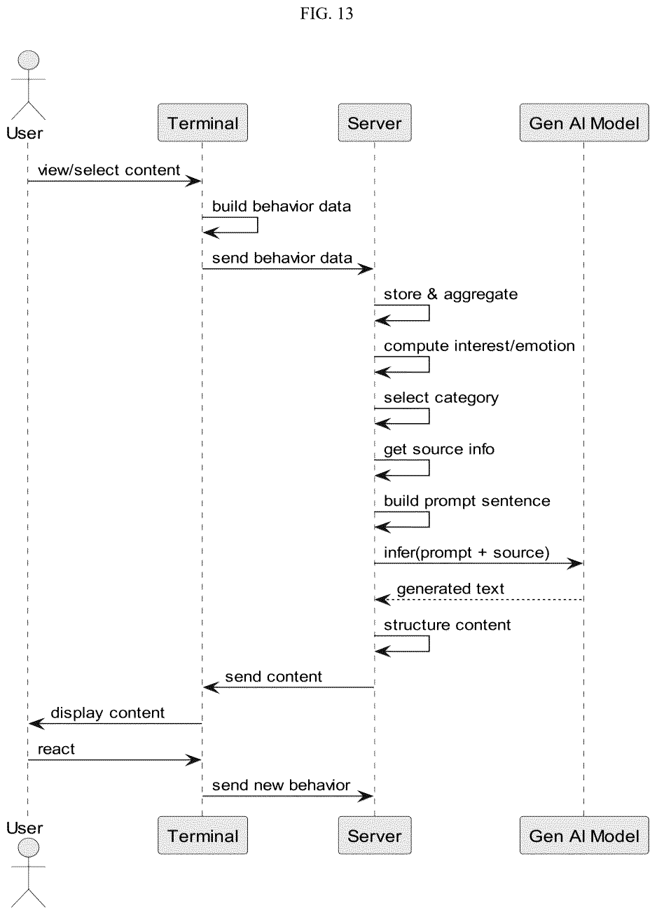

The following describes the processing flow using FIG. 13.

### Step 1:

User operates the terminal to view content and indicate interests.

User taps topic buttons, scrolls article lists, opens articles, and optionally selects favorite categories. The input is user actions on the terminal UI (touch events, clicks, scrolls, and selections). The output is raw interaction events at the terminal side, including at least a view start time, view end time, article identifier, category identifier, and action type.

### Step 2:

Terminal generates behavior information records from the raw interaction events.

Terminal converts the low-level interaction events into structured records, for example by computing dwell time as the difference between view end time and view start time and by associating each event with a user identifier and device identifier. The input is the raw interaction events produced in Step 1. The output is a set of behavior information records, each including user ID, content ID, category, timestamp, dwell time, scroll depth, and interaction type. Terminal stores these records in a local buffer until transmission.

### Step 3:

Terminal transmits behavior information to the server.

Terminal packs the buffered behavior information records into a structured message and sends the message to the server via a network protocol such as HTTPS. The input is the set of behavior information records stored in the local buffer. The output is a network request message carrying the behavior information, which is received by the server and cleared from the terminal buffer. Terminal may compress the payload and attach authentication data before transmission.

### Step 4:

Server receives and stores the behavior information.

Server validates the incoming request, parses the message format, and checks user authentication. The input is the network request message received from the terminal in Step 3. The server performs data parsing and schema validation to map the received fields into internal database columns. The output is stored behavior information in a behavior log table, where each record is indexed by user ID and timestamp for later retrieval.

### Step 5:

Server aggregates behavior information and constructs time-series data.

Server retrieves recent behavior information records for a user from the database. The input is the stored behavior information records corresponding to the user. Server performs data aggregation operations, such as summing dwell times per category, counting article views, and ordering events by timestamp to form a time series. The output is a set of aggregated metrics per information classification and a time-series sequence of events used for trend analysis.

### Step 6:

Server computes user interest scores and defines a user interest field.

Server takes the aggregated metrics as input and applies a scoring function. The input is per-category counts, dwell times, and recency values obtained in Step 5. Server may compute, for each category, an interest score using a weighted sum of normalized dwell time, view frequency, and a recency decay factor. The output is an interest score vector, where each dimension corresponds to a category, and a user interest field defined as the subset of categories whose scores satisfy a threshold or rank among the top N categories.

### Step 7:

Server estimates a user emotional state from reaction information.

Server extracts reaction-related features from the behavior information, such as bounce rate, rapid closing events, likes-to-views ratio, and scroll depth distribution. The input is the behavior information and aggregated metrics computed in Step 5. Server performs a classification operation using a trained classifier, for example a small neural network or a statistical model, that maps feature vectors to an emotional state label such as positive, neutral, or negative. The output is a current emotional state estimate for the user, optionally with a confidence value.

### Step 8:

Server calculates priorities for information classifications based on interest scores and emotional state.

Server uses the interest score vector and the estimated emotional state as input. Server multiplies each category's interest score by a weight corresponding to the emotional state, retrieved from a weight table, and then normalizes the result to compute a priority value for each category. The output is a priority list of information classifications, sorted in descending order of priority. Server marks the top-ranked classifications as target classifications for content generation.

### Step 9:

Server retrieves source information from an information source using the target classifications.

Server formulates search queries using the target classifications and optional keywords derived from high-frequency terms in the user's behavior history. The input is the list of target classifications obtained in Step 8. Server executes queries against a content index or database, filtering by classification and freshness criteria such as publication date. The output is a set of source documents, each including a title, body text, metadata, and a classification label. Server may truncate long documents or extract key paragraphs for use as source information.

### Step 10:

Server preprocesses the source information for use in a prompt sentence.

Server applies natural language processing to the retrieved source documents. The input is the set of source documents from Step 9. Server performs tokenization, sentence segmentation, keyword extraction, and optional summarization to convert each document into a compact representation, such as bullet-point facts or short summaries. The output is structured source information, including document summaries and extracted key phrases, ready to be appended to a prompt sentence.

### Step 11:

Server generates a prompt sentence based on the user interest field, emotional state, and source information.

Server accesses a prompt template library and selects a template appropriate for the target classifications and emotional state. The input is the user interest field from Step 6, the emotional state from Step 7, the priority list from Step 8, and the structured source information from Step 10. Server fills template slots with dynamic parameters, such as target category, desired length, desired writing style, and desired tone, to build a prompt sentence instructing the generative AI model. The output is a complete prompt sentence that includes an instruction segment and may reference the structured source information.

### Step 12:

Server constructs the input sequence to the generative AI model.

Server concatenates the prompt sentence with the structured source information and formats it into a single text input. The input is the prompt sentence created in Step 11 and the structured source information. Server converts the combined text into a sequence of tokens according to the tokenizer associated with the generative AI model. The output is a tokenized input sequence stored in memory, ready to be processed by the model.

### Step 13:

Server executes inference of the generative AI model to generate text information.

Server feeds the tokenized input sequence into the generative AI model hosted on a processor or accelerator. The input is the tokenized sequence from Step 12. Server performs forward passes through multiple transformer layers, computing attention scores, applying weight matrices, and generating probability distributions over possible next tokens. Server then decodes the output tokens using a decoding algorithm, such as greedy decoding or beam search, to produce a sequence of output tokens. The output is generated text information, which is then converted back to readable text.

### Step 14:

Server structures the generated text into information content.

Server analyzes the generated text to identify heading, summary, and body sections, for example using delimiters enforced by the prompt or rule-based parsing. The input is the generated text information from Step 13. Server splits the text into a title-like first sentence, a summary paragraph, and a detailed body, and then assigns metadata such as category and generation time. The output is an information content object containing heading information, summary information, body information, and associated metadata in a structured format.

### Step 15:

Server converts the information content into distribution data and stores it.

Server serializes the information content object into a distribution format suitable for network transmission, such as a structured response message. The input is the structured information content from Step 14. Server may compress the data and add identifiers for tracking. Server writes a record of the generated content into a database table, linking it to the user ID and generation time. The output is distribution data stored on the server and ready for transmission to the terminal.

### Step 16:

Server transmits the distribution data to the terminal.

Server receives a content request from the terminal or initiates a push transmission via a notification service. The input is the stored distribution data associated with the user from Step 15 and a request or trigger from the terminal. Server sends the distribution data over the network to the terminal, possibly via a push notification channel. The output is a network response containing the information content, which arrives at the terminal for display.

### Step 17:

Terminal receives and displays the information content to the user.

Terminal parses the received distribution data to extract heading, summary, and body fields. The input is the network response from the server in Step 16. Terminal renders the heading and summary in a list view and the body in a detail view using its display subsystem. Terminal may trigger a notification with the heading text to attract user attention. The output is a visual presentation of the information content on the terminal screen, enabling the user to read and interact with the generated article.

### Step 18:

User reacts to the information content and generates new behavior information.

User scrolls through the article, spends time reading, may tap buttons such as like or bookmark, or may quickly close the content. The input is the presented information content and the terminal's UI controls. The output is a new set of raw interaction events at the terminal side, reflecting the user's reaction to the generated content, which are then converted again into behavior information by the terminal as in Step 2 and transmitted to the server as in Step 3, thereby closing the feedback loop for subsequent processing.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional information delivery systems that use machine learning or recommendation engines typically treat user behavior data, content generation, and emotion analysis as separate, loosely coupled components. In such systems, a server may log page views and clicks, a recommendation module may compute generic scores, and a separate content engine may generate or fetch articles. However, these systems usually do not construct and maintain tightly integrated user profiles and emotion profiles that directly and dynamically control how prompt sentences are generated for a generative AI model. As a result, the server often issues coarse, static, or heuristic prompts to the model, which leads to suboptimal use of the model's capabilities, redundant processing, and inconsistent personalization quality.

Further, existing systems generally do not implement a closed-loop control architecture in which the server evaluates the generation result information from the generative AI model, analyzes the emotional tendency of the result, and then automatically regenerates or rewrites the content through additional prompt sentences when the emotional tendency does not match a stored emotion profile. The lack of such iterative prompt control causes the server to either deliver content that is poorly aligned with a user's current emotion state or to require manual post-editing, thereby increasing latency and computational overhead while degrading user experience.

Moreover, many known architectures do not record and exploit a history of prompt sentences and corresponding user reactions as first-class system data to optimize the prompt generation rules themselves. In those architectures, the prompt sentences remain essentially hand-crafted and static, and the server does not adapt the sentence structure or instruction content based on empirical performance metrics such as engagement, dwell time, or feedback. Consequently, the computational resources of the generative AI model are not efficiently used, because the server cannot systematically converge toward more effective prompt patterns for different user segments and emotion states.

In addition, typical systems treat emotion analysis as an auxiliary feature applied only at the time of initial recommendation, and do not use an emotion profile in a unified way to jointly determine an information type, a presentation order, the presence or absence of notifications, and notification modes. This separation often results in fragmented decision-making logic across multiple services, additional communication overhead, and increased complexity in client applications that must compensate for server-side limitations.

Therefore, there is a need for an improved computer-implemented system and server-side processing architecture that: (1) integrates acquisition and storage of user behavior information and history information into structured record information; (2) generates and maintains both user profile information and emotion profile information through statistical processing, machine learning processing, and emotion analysis; (3) uses these profiles as primary control data for generating prompt sentences supplied to a generative AI model; (4) evaluates and, when necessary, automatically rewrites generation result information through additional prompt sentences to align emotional tendencies with stored emotion profiles; and (5) continuously optimizes prompt generation rules using stored prompt histories and reaction information. Such a system would improve operation of the server as a technical platform by reducing unnecessary model calls, lowering manual tuning, increasing relevance and stability of generated content, and enabling dynamic adjustment of information provision experiences in a way that existing architectures cannot efficiently achieve.

The specific processing by the specific processing unit 290 of the data processing device 12 in Application Example 2 is realized by the following means.

The present invention provides a server comprising a processor configured to acquire user behavior information and user history information from a user terminal and store the acquired information as record information in a storage apparatus, execute information analysis processing including statistical processing and machine learning processing on the stored record information to generate user profile information indicating a user interest field and a user preference characteristic, execute natural language processing including emotion analysis processing on evaluation information and input information acquired from the user to generate emotion profile information indicating a user emotion state and a user emotional preference, generate a prompt sentence on the basis of the user profile information and the emotion profile information, the prompt sentence instructing a generative AI model regarding content, expression style, and emotional tendency of target information to be generated, and transmit the prompt sentence to an information processing apparatus that implements the generative AI model, extract external information acquired from an external information supply apparatus on the basis of the user profile information and control content of custom information to be generated by including the extracted external information in the prompt sentence or by adding the extracted external information as input information to the generative AI model, execute evaluation processing and emotion analysis processing on generation result information acquired from the generative AI model and, when an emotional tendency of the generation result information does not match the emotion profile information, generate an additional prompt sentence instructing rewriting of the generation result information and transmit the additional prompt sentence to the generative AI model so as to adjust content and expression style of the generation result information, transmit adjusted generation result information to the user terminal as notification information, respond to a detailed information request corresponding to the notification information by providing the generation result information so as to perform individualized information provision for each user, and further store a generation history of the prompt sentence and reaction information of the user to the generation result information as record information and, on the basis of the stored record information, sequentially update a sentence structure and instruction content of the prompt sentence so as to optimize generation rules of the prompt sentence. This enables the server to implement an integrated, closed-loop control mechanism over generative AI-based content generation, in which user profiles and emotion profiles directly govern prompt construction, evaluation and rewriting of generation results are automatically performed on the server side without requiring manual intervention, and prompt generation rules are continuously improved based on empirical reaction data, thereby enhancing computational efficiency, personalization accuracy, and stability of information provision as a technical improvement to computer-based information delivery systems.

The term “user behavior information” refers to electronic data representing actions performed by a user with respect to digital content or services, including at least page views, content selections, click operations, scrolling operations, dwell times, search queries, and interaction events captured by a client device or application.

The term “user history information” refers to accumulated electronic records of past user interactions over time, including at least browsing logs, search logs, content consumption logs, feedback logs, and other time-series activity data associated with a user identifier.

The term “user terminal” refers to an electronic apparatus operated by a user, including at least a computing device equipped with a processor, a memory, a communication interface, and a display, such as a smartphone, a tablet, a notebook computer, a desktop computer, or a head-mounted display.

The term “record information” refers to structured electronic data stored in a storage apparatus, the data including at least fields indicating user identifiers, timestamps, content identifiers, categories, and interaction attributes derived from user behavior information and user history information.

The term “storage apparatus” refers to a hardware and software arrangement configured to store and retrieve electronic data, including at least a memory device or a non-transitory storage medium managed by a database management system or a file system.

The term “information analysis processing” refers to computer-implemented processing applied to record information, including at least data aggregation, feature extraction, and computation of statistical and machine-learned metrics used to derive higher-level attributes about a user or content.

The term “statistical processing” refers to operations in which a processor computes numerical values such as counts, frequencies, averages, variances, and correlations based on record information, and generates statistical indicators describing user behavior or content properties.

The term “machine learning processing” refers to processing in which a processor executes an algorithmic model trained on data, such as a classification model, a regression model, a clustering model, or a recommendation model, to infer or predict attributes such as user interests, preferences, or content relevance.

The term “user profile information” refers to electronic data representing inferred or determined characteristics of a user, including at least a user interest field, preference attributes, topic weights, and other profile parameters derived from information analysis processing.

The term “user interest field” refers to one or more abstract topic categories or subject domains, such as sports, technology, or environmental issues, to which a user shows relatively high engagement or preference as determined by analysis of record information.

The term “user preference characteristic” refers to a parameterized representation of the user's tendencies regarding content selection or consumption, including at least favored topics, favored styles, favored lengths, and preferred interaction patterns.

The term “evaluation information” refers to explicit or implicit feedback data provided by a user regarding presented information, including at least ratings, reaction signals, textual comments, and selections such as “like” or “dislike” operations.

The term “input information” refers to electronic data directly input by the user through an interface, including at least text strings, search queries, form inputs, and other manually entered content associated with presented information.

The term “natural language processing” refers to processing in which a processor analyzes or generates sequences of natural-language text, including at least tokenization, morphological analysis, syntactic analysis, semantic analysis, topic extraction, and sentiment or emotion detection.

The term “emotion analysis processing” refers to a type of natural language processing that estimates an affective state from text or signals, including at least determination of sentiment polarity and categorization into emotional states such as joy, sadness, anger, or anxiety.

The term “emotion profile information” refers to electronic data representing one or more emotional attributes associated with a user, including at least a current emotion state, long-term emotional tendencies, and preferred emotional tone for information presentation.

The term “user emotion state” refers to an estimated or inferred current affective condition of the user, represented as one or more labels or scores along emotional dimensions such as positivity, negativity, arousal, or discrete emotion categories.

The term “user emotional preference” refers to characteristics indicating which emotional tones, such as positive, neutral, or calming content, the user generally prefers to receive in association with particular topics or contexts.

The term “prompt sentence” refers to a sequence of natural-language text that instructs a generative AI model regarding a content generation task, including at least directives specifying a topic, style, length, structure, and emotional tendency of target information to be generated.

The term “generative AI model” refers to an artificial intelligence model configured to generate new information, such as natural-language text, in response to an input prompt, the model being implemented by a computational system including at least one processor and one memory.

The term “information processing apparatus that implements the generative AI model” refers to a computing system, which may be local or remote, configured to execute the generative AI model, receive a prompt sentence as input, and output generation result information.

The term “content” refers to information items that can be provided to a user, including at least textual articles, summaries, messages, notifications, or other machine-generated information structures.

The term “expression style” refers to characteristics of a generated text, including at least tone, vocabulary level, writing format, degree of formality, and structural pattern such as bullet points or narrative paragraphs.

The term “emotional tendency” refers to an overall affective orientation of generated information, including at least degree and direction of positivity or negativity, and emphasis on hopeful, neutral, or cautionary expressions.

The term “external information” refers to information obtained from a source outside the server, including at least data acquired from content feeds, external databases, application programming interfaces, or other network-based information providers.

The term “external information supply apparatus” refers to a computer system or service that provides external information, including at least a content distribution system, a data feed server, or an information service platform.

The term “custom information” refers to generated information that has been adapted or specialized for an individual user or a user segment, based on user profile information, emotion profile information, and optionally external information.

The term “generation result information” refers to output data produced by the generative AI model in response to a prompt sentence, including at least the generated text and any associated metadata.

The term “evaluation processing” refers to processing in which the server assesses properties of generation result information, including at least checking length, content suitability, topic coverage, consistency with instructions, and relevance to stored profiles.

The term “additional prompt sentence” refers to a prompt sentence generated after initial generation result information has been obtained, the additional prompt sentence instructing modification, rewriting, or refinement of the generation result information.

The term “notification information” refers to condensed information used to inform the user that certain custom information is available, including at least a title, a short description, or an alert message delivered through a notification channel.

The term “detailed information request” refers to a request message initiated by a user terminal in response to notification information, the request indicating that the user desires to access the corresponding generation result information.

The term “individualized information provision” refers to an operation in which content is delivered to users in a manner that is tailored to each user's user profile information and emotion profile information, rather than uniformly across all users.

The term “generation history of the prompt sentence” refers to stored records of prompt sentences previously generated and transmitted to the generative AI model, including at least the text of each prompt, associated user identifiers, timestamps, and context parameters.

The term “reaction information” refers to data representing how a user responded to generation result information, including at least explicit feedback, interaction metrics such as dwell time and click behavior, and derived sentiment or emotion signals.

The term “sentence structure of the prompt sentence” refers to an arrangement of linguistic elements within a prompt sentence, including at least ordering of clauses, phrasing of instructions, and inclusion or exclusion of contextual segments.

The term “instruction content of the prompt sentence” refers to substantive directives expressed within a prompt sentence, including at least specification of topic, target style, output length, perspective, level of detail, and emotional orientation.

The term “generation rules of the prompt sentence” refers to a set of parameters, templates, or algorithms used by the server to construct prompt sentences, the rules defining how user profile information, emotion profile information, and external information are mapped to prompt text.

The term “information type” refers to a category or format of information to be generated or presented, including at least news articles, summaries, explanations, recommendations, or question-and-answer style responses.

The term “presentation order” refers to a sequence in which multiple information items are arranged for display or delivery to a user, determined based on one or more criteria such as relevance, recency, or emotional impact.

The term “notification mode” refers to a modality or style by which notification information is delivered to the user terminal, including at least push notifications, in-application banners, email alerts, or other signaling mechanisms.

The term “affirmative content” refers to information that is predominantly positive, supportive, or hopeful in tone, and that tends to elicit positive emotional responses from a user.

The term “low-burden content” refers to information that is designed to impose relatively low cognitive or emotional load on the user, such as short summaries, simplified explanations, or content presented in a calming or neutral tone.

The term “information provision experience” refers to a user-perceived quality and behavior of the overall process by which information is selected, generated, presented, and updated on the user terminal.

In one embodiment, a server, a terminal, and a communication network constitute a system that implements individualized information provision based on a generative AI model. The server includes at least one processor, a memory, and a storage apparatus such as a relational database system. The terminal includes at least one processor, a memory, a display, and a communication interface. The user operates the terminal to consume information, provide feedback, and thereby cause the server to generate and adjust prompt sentences supplied to the generative AI model.

The server executes a program stored in the memory. The program causes the server to acquire user behavior information and user history information from the terminal, to perform structured storage and analysis of such information, to construct user profile information and emotion profile information, and to generate a prompt sentence for the generative AI model based on these profiles. The generative AI model is implemented in an information processing apparatus that may be provided as a remote service accessible through an application programming interface. The server receives generation result information from the generative AI model, evaluates the information including its emotional tendency, and when necessary generates an additional prompt sentence to rewrite or refine the generation result information. The server then transmits adjusted generation result information to the terminal and responds to detailed information requests from the terminal.

In one concrete configuration, the server runs on a computer system that includes a multi-core central processing unit, a main memory, a non-transitory storage device such as a solid-state drive, and a network interface controller. The server may execute an operating system such as a UNIX-like operating system and an application framework such as a web server and an application server. The storage apparatus may be implemented by a database management system such as a relational database. The server may further use software libraries for data analysis (for example, a data frame library and a numerical library), machine learning (for example, a model training framework), and natural language processing (for example, tokenization, sentiment analysis, and topic extraction libraries). The server may also invoke external emotion analysis services through network requests.

The terminal runs an application, such as a web browser or a native application, that includes client-side logic for logging user behavior information. The terminal may execute JavaScript code in a browser or an application software development kit inside a native application to record user behavior information such as page views, content selections, scrolling operations, dwell times, search queries, and explicit reactions (for example, “like” or “dislike” inputs). The terminal associates each recorded event with a user identifier and a timestamp and transmits the resulting structured data to the server using a secure communication protocol.

The server stores user behavior information and user history information in record information structures. For example, the server may create relational tables such as a page view table, a search log table, and a feedback table, each table containing fields for a user identifier, a content identifier, a category identifier, a timestamp, and one or more numeric or categorical attributes such as dwell time, click position, or rating. The server uses these structures to efficiently perform join operations, group-by operations, and index-based retrieval. This structured storage improves data management and enables the server to compute statistical features and machine-learned features in a scalable and consistent manner.

The server performs information analysis processing on the record information to generate user profile information. The server loads a subset of the record information for each user as a data matrix, where each row corresponds to an interaction event and each column corresponds to a numerical or categorical feature. The server applies statistical processing to compute aggregated values such as counts of interactions per category, mean dwell times per topic, and frequency of searches containing specific terms. The server then applies machine learning processing, for example using a clustering algorithm or a classification model trained on historical data, to infer a user interest field and a user preference characteristic. Features for this model may include normalized category frequencies, dwell-time distributions, and text-derived topic vectors.

In one embodiment, the server uses a vector representation of content topics. The server converts article titles and search queries into vector representations using a natural language processing pipeline. The pipeline may include tokenization, vocabulary lookup, word embedding mapping, and averaging of word vectors to obtain a content vector. The server then applies a topic assignment algorithm such as k-means clustering or a neural topic model to map each content vector to a topic index. A user profile vector is computed as a weighted sum of topic vectors, where weights reflect dwell times and explicit positive feedback. This representation allows efficient similarity computations and fast retrieval of related content during prompt construction.

The server also generates emotion profile information through emotion analysis processing.

The server processes evaluation information and input information acquired from the user, including text comments, explicit emotion labels, and reaction selections. The server uses natural language processing techniques to perform sentiment analysis and emotion classification, for example by applying a classifier trained on labeled data with features such as term frequency-inverse document frequency (TF-IDF) values, word embeddings, and syntactic features. The classifier may be implemented as a neural network, such as a recurrent neural network or a transformer-based classifier with layers for self-attention and feed-forward processing. The classifier outputs emotion scores for classes such as joy, sadness, anger, fear, and neutrality.

The server aggregates these emotion scores over a time window to estimate a user emotion state, such as “currently sad but historically prefers positive content on environmental topics.” The server stores this emotion profile information in a dedicated table, with fields for current emotion labels, confidence scores, preferred emotional tone per topic, and historical statistics such as the distribution of user reactions to different emotional tones. By storing such emotion profile information as structured data, the server can use retrieval and update operations that are more efficient than re-evaluating all raw feedback data each time a decision is needed.

The server generates a prompt sentence to be supplied to the generative AI model. The server uses the user profile information and the emotion profile information as primary control inputs. In one embodiment, the server constructs the prompt sentence using a template engine. The template engine selects a template based on the user interest field and the intended content type. The server fills template slots with parameters derived from the user profile information and the emotion profile information. The server also inserts external information as contextual text for the generative AI model.

For example, when the user is highly interested in a particular sports tournament, the server may generate a prompt sentence such as:
“The user is highly interested in the Soccer World Cup. Using the following headlines and snippets, generate a concise news article summarizing today's main World Cup matches and key player performances: [headlines and snippets].”

When the user is interested in environmental issues and prefers positive content, the server may generate a prompt sentence such as:
“The user is interested in environmental issues and prefers positive stories. Please generate a 600-word, optimistic article about recent successful environmental protection efforts and new green technologies.”

When the server intends to extract topics from a history of queries, the server may generate a prompt sentence such as:
“From the following search history text, extract the main topics of interest related to environmental issues and list them as concise keywords: [search history].”

Furthermore, when the server determines that the user is currently in a negative mood, for example sadness, the server may generate a prompt sentence for rewriting a previously generated article, such as:
“The following article is too negative for a user who is currently feeling sad. Rewrite this article in a hopeful and encouraging tone, focusing on solutions and positive developments: [original article text].”

The server transmits each generated prompt sentence to the information processing apparatus that implements the generative AI model. The generative AI model may be a neural network that follows a transformer architecture with multiple layers of self-attention and feed-forward connections. The model may use learned word embeddings, positional encodings, and attention heads to compute an output sequence token by token. The model may be trained using a large corpus of text data and an optimization algorithm such as stochastic gradient descent with an adaptive learning rate, minimizing a loss function based on prediction error over token sequences. During training, the model updates internal parameters, such as weights in attention layers and feed-forward layers, based on gradient computations. The generative AI model thus learns statistical relationships between tokens and is capable of following instructions in prompt sentences to generate coherent text.

The server calls the generative AI model via an application programming interface. The server constructs a request object containing the prompt sentence, a maximum generation length, a temperature parameter that controls randomness, and additional parameters such as a top probability threshold for token selection. The generative AI model processes the prompt sentence as input, computes attention over the sequence, and produces a probability distribution over tokens at each step. The model then chooses tokens according to the specified decoding strategy and returns the generated text as generation result information. The server receives this generation result information and stores it in a generation result table, linking the information to the user identifier, the prompt identifier, and metadata such as timestamps and parameters used.

The server then performs evaluation processing and additional emotion analysis processing on the generation result information. The server may apply static rules such as maximum length checks, forbidden-word filters, and structural checks to ensure that the generation result information meets safety and format requirements. The server also applies emotion analysis processing similar to that used for user feedback, but this time targeted at the generated text. The server determines the emotional tendency of the generation result information by computing a polarity score and a distribution over emotion categories. The server then compares the emotional tendency profile of the generation result information with the stored emotion profile information for the user.

If the server determines that the emotional tendency of the generation result information conflicts with the user emotion state or user emotional preference, the server generates an additional prompt sentence for rewriting. For example, if the generation result information emphasizes negative aspects of environmental issues and the user is currently sad and prefers positive content, the server generates a rewriting prompt sentence similar to the one described above, inserting the text of the generation result information into a slot of the rewriting template. The server transmits this additional prompt sentence to the generative AI model, receives a revised generation result information, and repeats evaluation processing if necessary until the emotional tendency matches the emotion profile information within a predefined threshold.

The server records a generation history of prompt sentences and associated user responses.

The server stores each prompt sentence, along with the context such as the user profile information at generation time, the emotion profile information, the generation result information, and subsequent user reaction information (for example, click-through rate, dwell time, and feedback). The server uses this accumulated data as training data or adaptation data to update prompt generation rules. For example, the server may implement a separate model or heuristic that selects between multiple prompt templates based on predicted engagement. The server may treat each prompt template as an arm in a multi-armed bandit algorithm and dynamically allocate more probability to templates that historically led to higher user satisfaction. By doing so, the server reduces the number of ineffective prompts and thereby reduces the number of redundant calls to the generative AI model and the amount of network and computation resources consumed.

The terminal displays notification information and generation result information to the user through a graphical user interface. The terminal may show a short notification banner indicating that new custom information is available, and upon user selection, may display the full generation result information including a title, main body, and associated metadata. The terminal may also provide interface elements that allow the user to provide feedback, such as rating buttons, emotion selection controls, and comment input boxes. The terminal transmits the user's feedback to the server, closing the loop of behavior information acquisition and profile updating.

This configuration yields specific technical effects. Because the server uses structured record information and profile information to control prompt sentence generation, the server reduces computational waste that would otherwise occur if the generative AI model were asked to produce broad, unconditioned content. The use of user profile information and emotion profile information as explicit control data for prompt construction reduces the search space of possible outputs and therefore enables shorter response times and more stable outputs for the same hardware resources. The evaluation and rewriting mechanism further reduces the need for human correction, thereby lowering latency and reducing storage of unusable content.

From the perspective of computer technology, the system improves memory usage and data management by defining specific data structures for record information, profile information, and generation histories, enabling efficient indexing and fast query operations. The system also improves computation efficiency by applying machine learning processing and natural language processing in defined stages, minimizing redundant analysis by caching intermediate profile data and reusing such data in subsequent prompt generation. Because the server performs emotion analysis on both user input and generation result information and uses structured comparison of emotion representations, the system can algorithmically enforce emotional constraints on generated content without human intervention.

The system also reduces communication load by sending only compact prompt sentences and necessary context to the generative AI model, rather than complete raw logs or full historical data. Likewise, the server sends condensed notification information to the terminal and only transmits full generation result information upon explicit request from the terminal, thereby avoiding unnecessary data transfer. These design choices result in measurable reductions in bandwidth usage and improvements in response time under high load conditions.

The server and the generative AI model further implement processing that differs from manual human tasks. The server does not simply encode human decision logic, but uses non-conventional rules derived from data-driven learning. For example, the server may assign higher probability to prompt templates that emphasize particular syntactic constructions or instruction orders that empirical data show to yield higher quality generations, even though such constructions may be non-intuitive to a human operator. The system thus implements a distinct computational strategy that adjusts low-level language properties of prompt sentences as a function of observed machine-response and user-response patterns. This approach extends beyond automating human editorial work and constitutes an improvement in computer-centric control of large-scale language generation systems.

Alternative embodiments may vary in the specific algorithms and architectures used. In one alternative, the server may employ a neural recommendation model to predict the expected engagement for a candidate prompt sentence before issuing it to the generative AI model. In another embodiment, the server may implement the generative AI model locally, for example on a graphics processing unit-equipped server, and may adjust internal decoding parameters such as beam width and length penalties in accordance with user profile information and emotion profile information. In yet another embodiment, the server may use different emotion classification architectures, such as convolutional networks or hybrid models with both lexical and contextual features.

In all these embodiments, the technical core remains that the server uses explicitly computed profile information to dynamically and programmatically control the content, form, and emotional tendency of prompt sentences supplied to the generative AI model, evaluates resulting outputs, and applies automatic rewriting when necessary, and that the server continuously refines prompt generation rules based on a history of prompts and user reactions. This structured combination of data representations, machine-learned models, and control logic yields improvements in computational efficiency, personalization accuracy, and robustness of content generation that would not be realized by conventional static recommendation pipelines or by simple automation of human editorial processes.

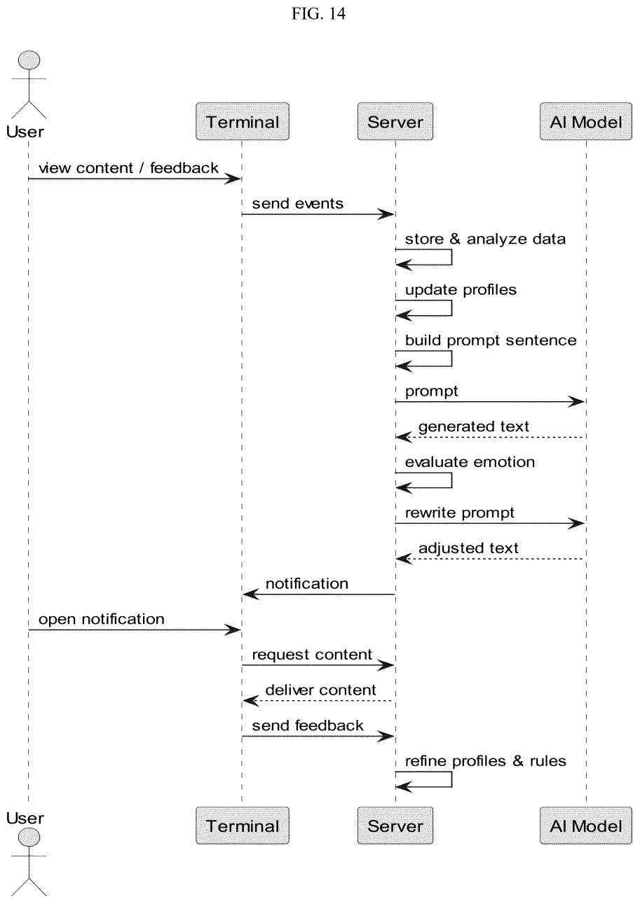

The following describes the processing flow using FIG. 14.

### Step 1:

The terminal records user behavior information during content use.

The terminal receives input in the form of user operations, including page views, scroll events, click events, dwell times, search queries, and feedback button presses.

The terminal executes client-side tracking logic, assigns a user identifier and timestamp to each event, and converts the events into structured records such as ‘{user_id, content_id, category_id, action_type, dwell_time, timestamp}’.

The terminal outputs a batch of structured behavior records and transmits the batch to the server via a network interface using a secure protocol.

### Step 2:

The server receives and stores user behavior information and user history information.

The server receives input in the form of structured behavior records from the terminal.

The server parses the records, validates mandatory fields, converts data types (for example, timestamps to a unified format), and writes the data into tables such as a page view table, a search log table, and a feedback table in a storage apparatus.

The server outputs updated record information stored in the database, indexed by user identifier and content identifier.

### Step 3:

The server generates user profile information from record information.

The server receives input in the form of record information corresponding to a specific user, retrieved with a query by user identifier and time range.

The server performs data aggregation operations, including grouping records by category, counting the number of interactions per category, and computing average dwell times, and then normalizes these statistics to obtain feature vectors.

The server applies a machine learning model to the feature vectors, such as a clustering model or a classifier, and computes a user interest field and user preference characteristics.

The server outputs user profile information, including a set of topic weights, main interest categories, and preference parameters, and stores this information in a profile table.

### Step 4:

The server generates emotion profile information from evaluation information and input information.

The server receives input in the form of textual comments, reaction labels, and explicit ratings associated with user interactions, retrieved from a feedback table.

The server applies natural language processing, including tokenization, feature extraction using term frequency-based representations or embeddings, and emotion classification using a trained classifier, and computes emotion scores for categories such as joy, sadness, anger, and neutrality.

The server aggregates emotion scores across multiple interactions over a time window, calculates average and recent emotion tendencies, and correlates these with topics contained in the user profile information.

The server outputs emotion profile information, including a current user emotion state and user emotional preferences per topic, and stores this information in an emotion profile table.

### Step 5:

The server acquires and filters external information as contextual data.

The server receives input in the form of a request to update or generate content for a user, together with user profile information.

The server sends queries to one or more external information supply apparatuses, specifying parameters such as topic keywords or category identifiers derived from the user profile information, and receives external information such as titles, summaries, and metadata.

The server filters the external information using keyword matching, topic similarity, and recency conditions, and selects a set of relevant items associated with the user interest field.

The server outputs a set of contextual external information items and stores or caches them for use in prompt sentence construction.

### Step 6:

The server generates a primary prompt sentence for the generative AI model.

The server receives input in the form of user profile information, emotion profile information, and contextual external information items.

The server selects a prompt template based on the user interest field, desired content type, and current emotion state, and then fills template parameters such as topic names, desired length, and emotional tendency.

The server inserts portions of the external information, for example headlines and snippets, into the template as context, and concatenates all components into a single natural-language prompt sentence.

The server outputs a prompt sentence that instructs the generative AI model regarding content, expression style, and emotional tendency.

### Step 7:

The server transmits the prompt sentence to the generative AI model and receives generation result information.

The server receives input in the form of the prompt sentence and generation parameters such as maximum token length and randomness controls.

The server constructs a request object, embeds the prompt sentence and parameters, and sends the request to an information processing apparatus implementing the generative AI model using a communication interface.

The generative AI model processes the prompt sentence, generates a sequence of output tokens, and returns the generated text as generation result information; the server receives this generation result information and records associated metadata such as prompt identifier and time of generation.

The server outputs initial generation result information tied to a specific prompt sentence and user.

### Step 8:

The server evaluates and analyzes the emotional tendency of the generation result information.

The server receives input in the form of the generation result information and the corresponding emotion profile information of the user.

The server applies evaluation rules to check properties such as length, presence of disallowed terms, and structural completeness, and applies emotion analysis processing to the generation result information to obtain an emotional tendency profile.

The server compares the emotional tendency profile with the stored user emotion state and emotional preferences, and computes a match score indicating how well the generated content aligns with the emotion profile.

The server outputs a decision result indicating whether the generation result information is acceptable or requires rewriting, together with the computed emotional tendency profile.

### Step 9:

The server generates an additional prompt sentence when rewriting is required.

The server receives input in the form of generation result information and the decision result indicating that the emotional tendency does not match the emotion profile information.

The server selects a rewriting template that specifies modification instructions, such as shifting to a more positive or calming tone, and embeds the entire generation result information as a quoted or referenced text inside the template.

The server constructs an additional prompt sentence that instructs the generative AI model to rewrite or adjust the generation result information, for example by emphasizing solutions instead of problems or increasing positivity.

The server outputs the additional prompt sentence and transmits it to the generative AI model as a new request.

### Step 10:

The server receives adjusted generation result information and finalizes content.

The server receives input in the form of the generative AI model's response to the additional prompt sentence.

The server performs evaluation processing and emotion analysis again on the adjusted generation result information, checks that the emotional tendency satisfies a predetermined threshold of alignment with the emotion profile, and optionally normalizes formatting and length.

The server selects the adjusted generation result information as final content for the user and stores it in a generation result table together with identifiers of all prompt sentences used in the generation and rewriting process.

The server outputs finalized custom information prepared for delivery to the terminal.

### Step 11:

The server constructs and sends notification information to the terminal.

The server receives input in the form of finalized custom information and a delivery policy derived from user profile information and emotion profile information.

The server generates a notification summary, including a title or short description extracted or synthesized from the finalized custom information, and associates a content identifier and relevant metadata.

The server sends the notification information to the terminal via a notification channel, such as a push messaging service, including only compact summary data to minimize bandwidth usage.

The server outputs a state indicating that the terminal has been informed of the availability of new custom information.

### Step 12:

The terminal displays notification information and requests detailed content.

The terminal receives input in the form of notification information from the server.

The terminal displays a notification element on the user interface, showing a concise summary or title, and waits for a user interaction such as tapping or clicking the notification.

When the user selects the notification, the terminal constructs a detailed content request including the content identifier, and transmits this request to the server through an application interface.

The terminal outputs a request message that causes the server to send the corresponding finalized custom information.

### Step 13:

The server delivers finalized custom information to the terminal.

The server receives input in the form of a detailed content request including a content identifier and a user identifier.

The server queries the generation result table for the finalized custom information corresponding to the content identifier and user identifier, and retrieves the stored text and metadata.

The server packages the retrieved information into a response object containing the title, body text, topic labels, and any auxiliary data, and transmits the response object to the terminal.

The server outputs a data payload that enables the terminal to render individualized content for the user.

### Step 14:

The terminal renders the finalized custom information and collects user feedback.

The terminal receives input in the form of the data payload containing the finalized custom information and metadata from the server.

The terminal uses a rendering engine to present the title, main body, and other elements on the display, and provides user interface controls for rating, emotion selection, and comment entry.

The user reads the content and operates the controls to provide feedback, such as selecting an emotion label, setting a rating, or entering a short comment, and the terminal collects this feedback into structured fields.

The terminal outputs a feedback message that contains evaluation information and input information, and transmits the feedback message to the server.

### Step 15:

The server updates profiles and prompt generation rules using feedback and history.

The server receives input in the form of the feedback message and the corresponding prompt and generation history stored in the database.

The server attaches the feedback to the generation history of the prompt sentence, updates statistical counters such as engagement metrics, and re-runs emotion analysis on the user's comment to refine the emotion profile information.

The server adjusts user profile information by increasing or decreasing topic weights based on positive or negative reactions, and updates prompt generation rules by modifying template selection probabilities or rule parameters to favor prompt sentences that historically produce higher engagement and satisfaction.

The server outputs updated user profile information, updated emotion profile information, and updated prompt generation rule parameters, thereby closing the loop for subsequent executions of the generative AI model and prompt sentence generation.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

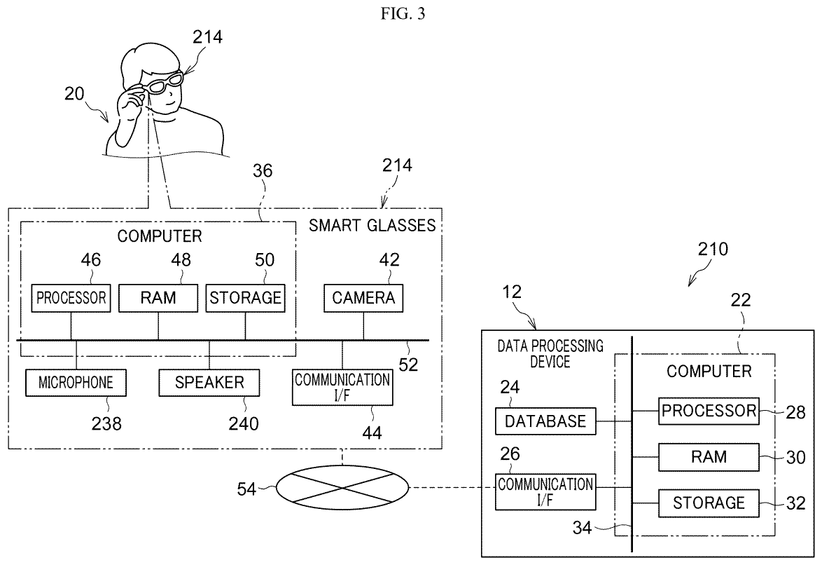

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

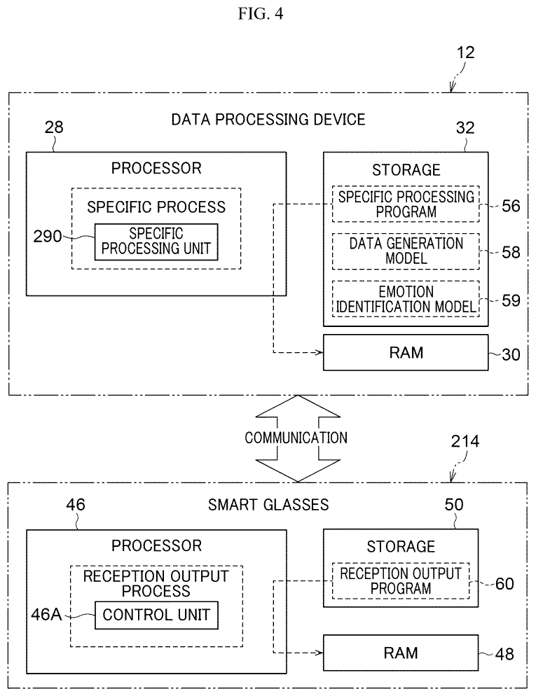

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

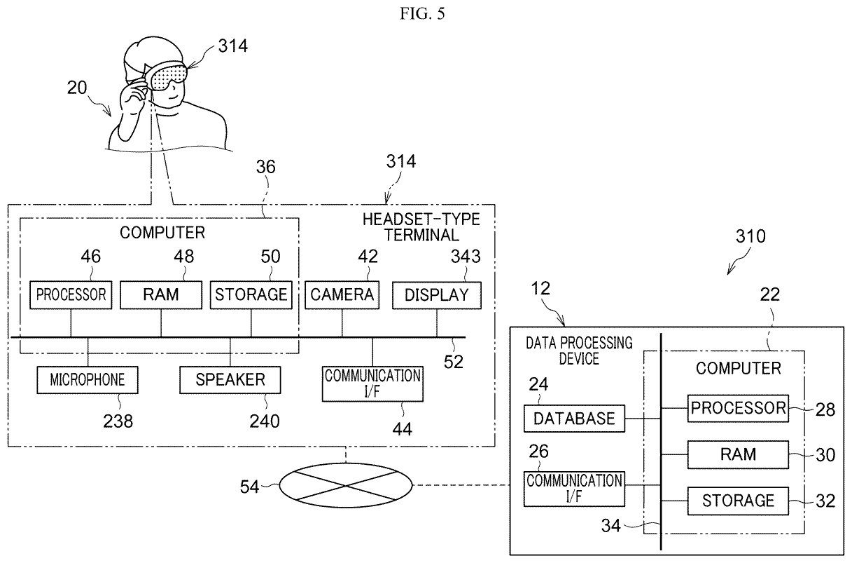

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

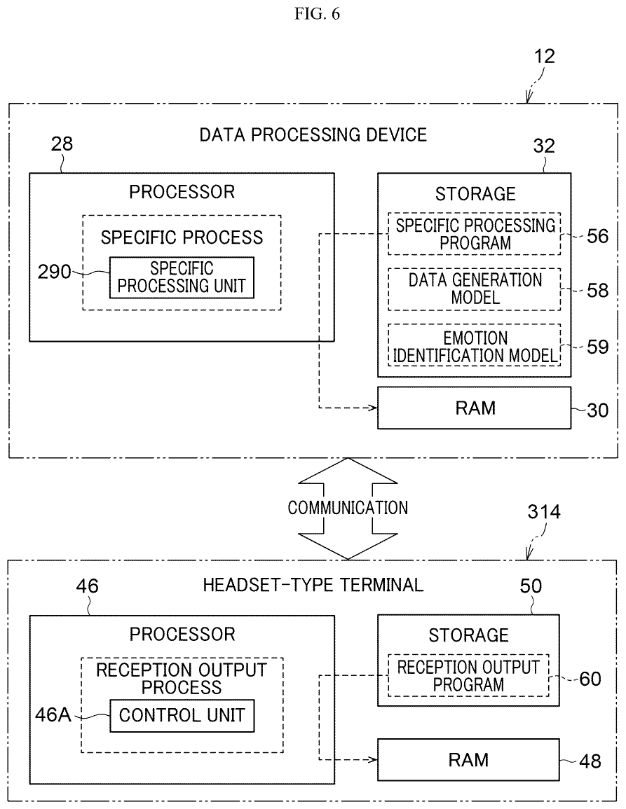

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

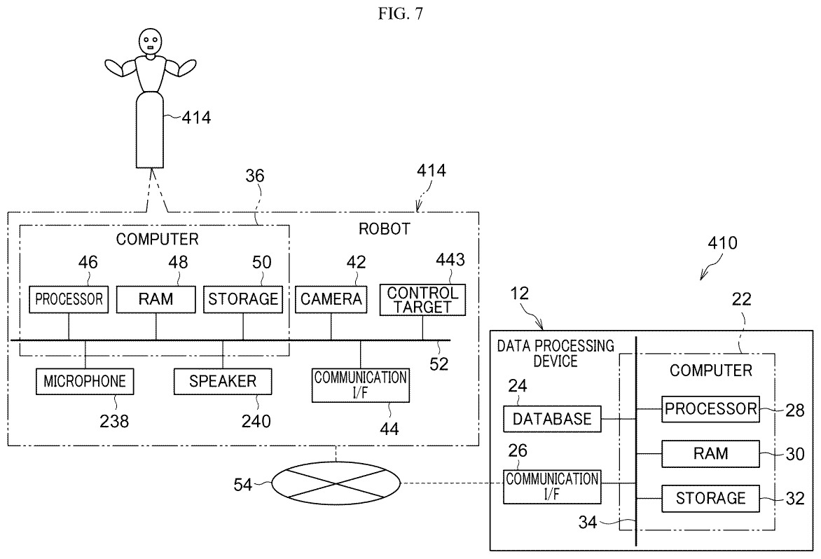

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

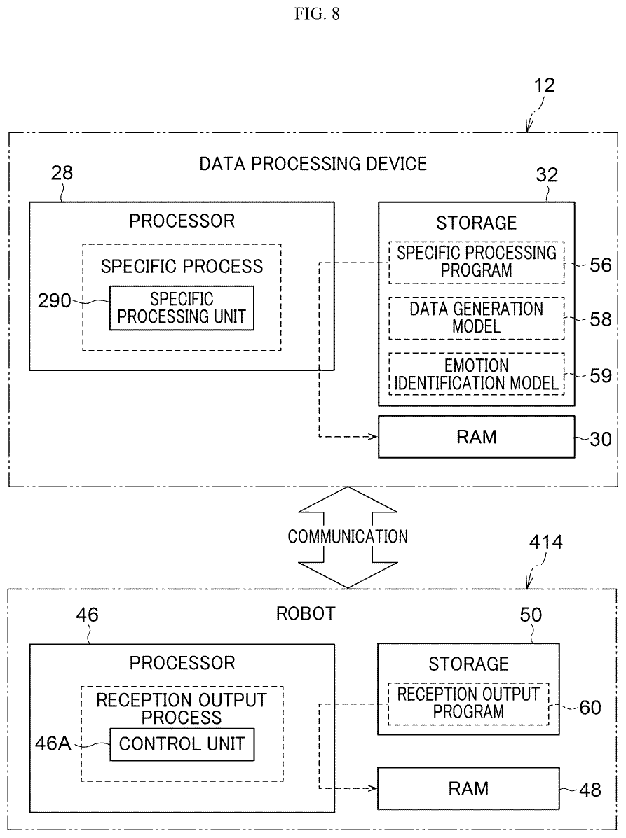

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

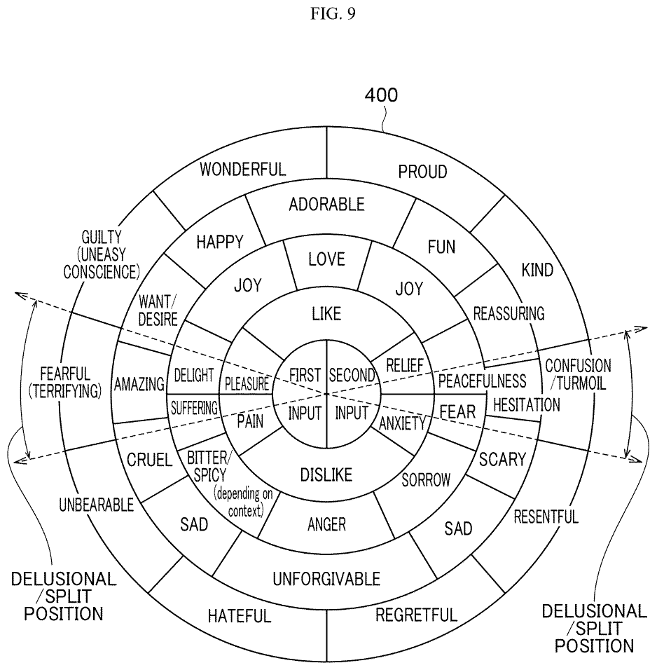

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

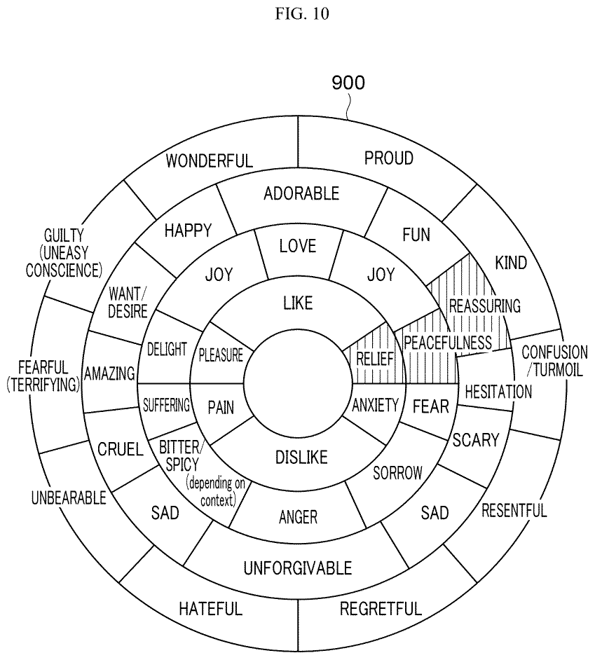

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire user behavior information from a terminal and store the user behavior information as structured data in a storage device,
perform statistical analysis processing on the stored user behavior information to generate attribute information indicating interests and preferences of a user,
generate context information by integrating the attribute information, a natural language request sentence obtained from the user, browsing history of the user, and related information sources,
generate a prompt sentence, based on the context information, for instructing a generative AI model in a generation processing apparatus to execute information generation processing, obtain custom information from the generative AI model by using the prompt sentence, and provide the custom information to the user terminal,
acquire, again as user behavior information, a history of viewing, operating, and sharing of the custom information by the user, and update the attribute information and content of the prompt sentence, thereby sequentially optimizing information generation and provision methods for subsequent information provision, and
recognize an emotional state of the user based on user interface information or the user behavior information, and adjust the information generation and provision methods by changing an expression style or a level of detail in the prompt sentence in accordance with the emotional state.

### Supplementary 2

The system according to supplementary 1,
wherein the processor is configured to generate, in the generation of the prompt sentence, a prompt sentence that customizes content and presentation format of next information provision by adding, into the prompt sentence, conditions specifying a configuration format of information, an explanation level, and an output length, using the attribute information generated based on the user behavior information and a reaction history of the user to the custom information.

### Supplementary 3

The system according to supplementary 1,
wherein the processor is configured to analyze the emotional state of the user, select an information category and a tone of information based on the emotional state, and generate the prompt sentence for instructing the generative AI model to execute the information generation processing by explicitly describing, in the prompt sentence, a type, a priority, and a presentation order of information to be generated in accordance with the selected information category and tone.

### Application Example 1

### Supplementary 1

A system comprising a processor,
wherein the processor is configured to
acquire behavioral information relating to an information acquisition operation of a user, convert the behavioral information into a structured information format, and store the behavioral information in an information storage device,
aggregate the behavioral information stored in the information storage device by executing statistical processing and feature extraction processing, and generate, for each user, a feature vector representing a degree of interest in an information field,
input the feature vector into a machine learning model and calculate a prediction result indicating an interest target and a degree of interest of the user,
generate, on the basis of the prediction result and the behavioral information, a prompt sentence in a natural language, the prompt sentence including a user identifier, the interest target, the information field, an output condition, and an output format, and provide the prompt sentence as an input to a generative artificial intelligence model so as to cause the generative artificial intelligence model to generate personalized information, acquire the personalized information output from the generative artificial intelligence model, convert the personalized information into a format displayable on a user information processing terminal, and distribute the personalized information to the user information processing terminal,
collect, as additional behavioral information, a reaction of the user to the personalized information on the basis of an operation history during information viewing, and update the feature vector and the prediction result so as to continuously optimize contents of the prompt sentence, and
estimate an emotional state of the user on the basis of the behavioral information and reaction information to the generated information, and adjust a method of information generation and provision by the generative artificial intelligence model by changing, in the prompt sentence, at least one of the information field, an amount of information, a writing style, and a presentation order in accordance with the emotional state.

### Supplementary 2

The system according to supplementary 1,
wherein the processor is configured to include, in the prompt sentence, a description that instructs the generative artificial intelligence model to customize contents of next information provision and a provision timing on the basis of viewing time, viewing frequency, and sharing frequency for each information field corresponding to the interest target.

### Supplementary 3

The system according to supplementary 1,
wherein the processor is configured to include, in the prompt sentence, a description that instructs the generative artificial intelligence model to determine a priority of the information field in accordance with the emotional state of the user, and to generate summary information, recommendation reasons, and explanatory information for information belonging to an information field having a high priority.

### Example 2

### Supplementary 1

A system comprising a processor,
wherein the processor is configured to
collect user behavior information including information acquisition history and interest information, and estimate a user interest field based on the behavior information and the interest information,
select an information classification corresponding to the user interest field, and generate a prompt sentence including instruction content for summarizing or reconstructing source information acquired from an information source based on the information classification and for instructing generation of custom information by a generative information processing apparatus,
input the prompt sentence and the source information to the generative information processing apparatus as a generative AI model, and cause the generative AI model to generate text information optimized for each user,
structure the generated text information, store the structured text information as information content including heading information, summary information, and body information, and convert the information content into distribution data for a user terminal,
transmit the information content to the user terminal, present the information content via a notification function or a display function of the user terminal, and collect additional behavior information relating to a presentation result again as the behavior information, and
estimate a user emotional state based on the behavior information and reaction information to the information content, and dynamically adjust the instruction content of the prompt sentence and a presentation format of the information content in accordance with the emotional state and the user interest field.

### Supplementary 2

The system according to supplementary 1,
wherein the processor is configured to
generate the prompt sentence by aggregating the user behavior information in a time series to calculate a reaction tendency to previous information content and adding to the prompt sentence instruction content for changing, for a next information provision, at least one of an information classification, an amount of text, and a writing style based on the reaction tendency.

### Supplementary 3

The system according to supplementary 1,
wherein the processor is configured to
estimate the emotional state and select the information classification by using weight information associated with the emotional state of the user to calculate a priority for each of a plurality of information classifications, determine at least one information classification based on the priority, and generate a prompt sentence instructing generation of information based on the determined information classification.

### Application Example 2

### Supplementary 1

A system comprising a processor,
wherein the processor is configured to
acquire user behavior information and user history information from a user terminal and store the acquired information as record information in a storage apparatus,
execute information analysis processing including statistical processing and machine learning processing on the stored record information to generate user profile information indicating a user interest field and a user preference characteristic,
execute natural language processing including emotion analysis processing on evaluation information acquired from the user and input information acquired from the user to generate emotion profile information indicating a user emotion state and a user emotional preference, generate a prompt sentence, on the basis of the user profile information and the emotion profile information, the prompt sentence instructing a generative AI model regarding content, expression style, and emotional tendency of target information to be generated, and transmit the prompt sentence to an information processing apparatus that implements the generative AI model,
extract external information acquired from an external information supply apparatus on the basis of the user profile information, and control content of custom information to be generated by including the extracted external information in the prompt sentence or by adding the extracted external information as input information to the generative AI model, execute evaluation processing and emotion analysis processing on generation result information acquired from the generative AI model, and when an emotional tendency of the generation result information does not match the emotion profile information, generate an additional prompt sentence instructing rewriting of the generation result information and transmit the additional prompt sentence to the generative AI model so as to adjust content and expression style of the generation result information, and
transmit adjusted generation result information to the user terminal as notification information, and, in response to a detailed information request corresponding to the notification information, provide the generation result information so as to perform individualized information provision for each user.

### Supplementary 2

The system according to supplementary 1,
wherein the processor is configured to
store a generation history of the prompt sentence and reaction information of the user to the generation result information as record information, and, on the basis of the stored record information, sequentially update a sentence structure and instruction content of the prompt sentence so as to optimize generation rules of the prompt sentence in a manner that increases usefulness of the custom information generated by the generative AI model and a degree of engagement of the user.

### Supplementary 3

The system according to supplementary 1,
wherein the processor is configured to
determine a type of information, a presentation order of information, presence or absence of notification, and a notification mode on the basis of the emotion profile information and the user profile information, control the prompt sentence to be supplied to the generative AI model so as to cause the generative AI model to preferentially generate information including affirmative content or low-burden content in accordance with a current emotion state of the user, and change a presentation method of the generation result information so as to dynamically adjust an information provision experience for the user.

What is claimed is:

1. A system comprising:
circuitry configured to:
receive, via a communication interface coupled to a packet-switched network, behavior data from a terminal device, and store the behavior data as structured data in a storage device;
apply a statistical analysis algorithm to the stored behavior data to generate attribute data indicating behavioral tendencies and interaction preferences of a user;
generate context data by integrating the attribute data, a natural language request sentence received from the terminal device, interaction history data, and data retrieved from one or more external data sources via the communication interface;
generate a prompt sentence based on the context data specifying instructions for a generative neural network model to execute content generation processing, and input the prompt sentence to the generative neural network model to obtain generated content data;
transmit the generated content data to the terminal device;
receive updated behavior data comprising a history of user interactions with the generated content data, update the attribute data and a content of the prompt sentence based on the updated behavior data to sequentially optimize subsequent content generation processing; and
apply an emotion recognition algorithm to at least one of user interface interaction data or the behavior data to generate an emotion state parameter, and adjust at least one of an expression style parameter or a detail level parameter of the prompt sentence based on the emotion state parameter.

2. The system according to claim 1, wherein the circuitry is configured to apply the statistical analysis algorithm to compute occurrence frequencies and dwell time metrics from the behavior data, generate a behavioral tendency vector from the occurrence frequencies and dwell time metrics, and store the behavioral tendency vector as the attribute data in the storage device.

3. The system according to claim 2, wherein the circuitry is configured to apply a natural language processing algorithm to the natural language request sentence to extract query terms and context parameters, integrate the query terms and context parameters with the behavioral tendency vector to generate the context data, and represent the context data as a structured data object for input to a prompt generation algorithm.

4. The system according to claim 3, wherein the circuitry is configured to generate the prompt sentence by selecting a prompt template based on a request type parameter derived from the query terms, substituting the context data into the prompt template, and appending output format specifications defining a content length and expression style.

5. The system according to claim 4, wherein the circuitry is configured to receive, as the updated behavior data, records of viewing durations, interaction events, and sharing events associated with the generated content data, compute an engagement metric from the received updated behavior data, and update the attribute data by adjusting the behavioral tendency vector based on the engagement metric.

6. The system according to claim 5, wherein the circuitry is configured to update the content of the prompt sentence by modifying at least one of the selected prompt template, the substituted context data, or the appended output format specifications based on the engagement metric, and apply the updated prompt sentence in a subsequent content generation processing cycle.

7. The system according to claim 1, wherein the circuitry is configured to apply a face analysis model or a voice analysis model to user interface interaction data received from the terminal device to extract affective feature data, apply an emotion classification model to the extracted affective feature data to generate the emotion state parameter, and classify the emotion state parameter into one of a plurality of emotional state categories.

8. The system according to claim 7, wherein the circuitry is configured to select an expression style adjustment strategy from a plurality of expression style adjustment strategies based on the classified emotional state category, modify the expression style parameter of the prompt sentence to reflect the selected adjustment strategy, and input the modified prompt sentence to the generative neural network model.

9. The system according to claim 8, wherein the circuitry is configured to detect a change in the emotion state parameter exceeding a state-change threshold between consecutive processing cycles, regenerate the prompt sentence incorporating the updated emotion state parameter, and supply the regenerated prompt sentence to the generative neural network model.

10. The system according to claim 1, wherein the circuitry is configured to retrieve related data from one or more external data sources via the communication interface based on the query terms extracted from the natural language request sentence, incorporate the retrieved related data into the context data, and generate an enriched prompt sentence incorporating the retrieved related data as supplemental context.

11. The system according to claim 10, wherein the circuitry is configured to apply a relevance-scoring algorithm to rank the retrieved related data by relevance to the query terms, select a subset of the retrieved related data ranked above a relevance threshold, and include only the selected subset in the context data to limit prompt sentence length to a predetermined token budget.

12. The system according to claim 1, wherein the circuitry is configured to generate a plurality of candidate prompt sentences each encoding different subsets of the context data, input each candidate prompt sentence to the generative neural network model to generate a plurality of candidate content data items, evaluate each candidate content data item using a quality metric computed from the attribute data, and select the highest-scoring candidate content data item for transmission to the terminal device.

13. The system according to claim 12, wherein the circuitry is configured to compute the quality metric by measuring a semantic similarity between each candidate content data item and the behavioral tendency vector, and selecting the candidate content data item with the highest semantic similarity score.

14. The system according to claim 1, wherein the circuitry is configured to store a history of generated prompt sentences, generated content data items, and emotion state parameters in the storage device indexed by a user session identifier, and supply stored history data from prior sessions as additional context in subsequent prompt sentence generation to improve long-term content generation consistency.

15. The system according to claim 14, wherein the circuitry is configured to apply a data retention policy to the stored history data by removing records older than a predetermined retention period, and apply a compression algorithm to records within the retention period to reduce storage device utilization.

16. The system according to claim 1, wherein the circuitry is configured to aggregate behavior data and attribute data across a plurality of users sharing a common behavioral tendency category, extract population-level behavioral patterns from the aggregated data, and incorporate the population-level behavioral patterns as supplemental context in prompt sentences generated for individual users within the plurality of users.

17. The system according to claim 1, wherein the circuitry is configured to apply an anomaly detection algorithm to incoming behavior data to detect interaction patterns deviating from stored attribute data by more than a deviation threshold, generate an alert notification when a deviation exceeding the threshold is detected, and update the attribute data more aggressively when the anomaly detection algorithm indicates a statistically significant behavioral shift.

18. A system comprising:
circuitry configured to:
receive, via a communication interface coupled to a packet-switched network, behavior data from a terminal device, apply a statistical analysis algorithm to the behavior data to generate attribute data, and store the attribute data in a storage device;
generate context data by integrating the attribute data, a natural language request sentence received from the terminal device, and interaction history data, and generate a prompt sentence based on the context data;
input the prompt sentence to a generative neural network model to obtain generated content data and transmit the generated content data to the terminal device;
receive updated behavior data comprising user interactions with the generated content data, update the attribute data and the prompt sentence content based on the updated behavior data; and
apply an emotion recognition algorithm to user interface interaction data to generate an emotion state parameter, and adjust at least one of an expression style parameter or a detail level parameter of the prompt sentence based on the emotion state parameter.

19. The system according to claim 18, wherein the circuitry is configured to apply a relevance-scoring algorithm to related data retrieved from external data sources to select a subset above a relevance threshold, incorporate the selected subset into the context data as supplemental context, and limit prompt sentence length to a predetermined token budget.

20. A method performed by circuitry, the method comprising:
receiving, via a communication interface coupled to a packet-switched network, behavior data from a terminal device, and storing the behavior data as structured data in a storage device;
applying a statistical analysis algorithm to the stored behavior data to generate attribute data indicating behavioral tendencies and interaction preferences of a user;
generating context data by integrating the attribute data, a natural language request sentence received from the terminal device, interaction history data, and data retrieved from one or more external data sources via the communication interface;
generating a prompt sentence based on the context data specifying instructions for a generative neural network model to execute content generation processing, and inputting the prompt sentence to the generative neural network model to obtain generated content data;
transmitting the generated content data to the terminal device;
receiving updated behavior data comprising a history of user interactions with the generated content data, updating the attribute data and a content of the prompt sentence based on the updated behavior data to sequentially optimize subsequent content generation processing; and
applying an emotion recognition algorithm to at least one of user interface interaction data or the behavior data to generate an emotion state parameter, and adjusting at least one of an expression style parameter or a detail level parameter of the prompt sentence based on the emotion state parameter.
